(19) United States
(12) Patent Application Publication
(10) Pub. No.: US 2023/0189319 A1
(43) Pub. Date: Jun. 15, 2023

(54) FEDERATED LEARNING FOR MULTIPLE ACCESS RADIO RESOURCE MANAGEMENT OPTIMIZATIONS

(71) Applicant: Intel Corporation, Santa Clara, CA (US)

(72) Inventors: Mustafa Riza Akdeniz, San Jose, CA (US); Nageen Himayat, Fremont, CA (US); Ravikumar Balakrishnan, Beaverton, OR (US); Sagar Dhakal, Los Altos, CA (US); Mark R. Eisen, Beaverton, OR (US); Navid Naderializadeh, Woodland Hills, CA (US)

(73) Assignee: Intel Corporation, Santa Clara, CA (US)

(21) Appl. No.: 17/921,549

(22) PCT Filed: Jun. 26, 2021
(86) PCT No.: PCT/US2021/039272

§ 371 Date: Oct. 26, 2022

Related U.S. Application Data
(60) Provisional application No. 63/053,547, filed on Jul. 17, 2020.

(51) Int. Cl. H04W 72/542; H04W 24/02; G06N 3/08

(52) U.S. Cl. CPC H04W 72/542; H04W 24/02; G06N 3/08

(57) ABSTRACT

In one embodiment, a machine learning (ML) model for determining radio resource management (RRM) decisions is updated, with ML model parameters being shared between RRM decision makers to update the model. The updates may include local operations (between an AP and UE pair) to update local primal and dual parameters of the ML model, and global operations (between other devices in the network) to exchange/update global parameters of the ML model.

### CROSS-REFERENCE TO RELATED APPLICATIONS

This Application claims the benefit of, and priority from, U.S. Provisional Patent Application No. 63/053,547, entitled “FEDERATED LEARNING FOR MULTIPLE ACCESS RADIO RESOURCE MANAGEMENT OPTIMIZATIONS” and filed Jul. 17, 2020, the entire disclosure of which is incorporated herein by reference.

### BACKGROUND

Edge computing, at a general level, refers to the implementation, coordination, and use of computing and resources at locations closer to the “edge” or collection of “edges” of the network. The purpose of this arrangement is to improve total cost of ownership, reduce application and network latency, reduce network backhaul traffic and associated energy consumption, improve service capabilities, and improve compliance with security or data privacy requirements (especially as compared to conventional cloud computing). Components that can perform edge computing operations (“edge nodes”) can reside in whatever location needed by the system architecture or ad hoc service (e.g., in a high performance compute data center or cloud installation; a designated edge node server, an enterprise server, a roadside server, a telecom central office; or a local or peer at-the-edge device being served consuming edge services).

Applications that have been adapted for edge computing include but are not limited to virtualization of traditional network functions (e.g., to operate telecommunications or Internet services) and the introduction of next-generation features and services (e.g., to support 5G network services). Use-cases which are projected to extensively utilize edge computing include connected self-driving cars, surveillance, Internet of Things (IoT) device data analytics, video encoding and analytics, location aware services, device sensing in Smart Cities, among many other network and compute intensive services.

Edge computing may, in some scenarios, offer or host a cloud-like distributed service, to offer orchestration and management for applications, coordinated service instances and machine learning, such as federated machine learning, among many types of storage and compute resources. Edge computing is also expected to be closely integrated with existing use cases and technology developed for IoT and Fog/distributed networking configurations, as endpoint devices, clients, and gateways attempt to access network resources and applications at locations closer to the edge of the network.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates various compute arrangements deploying containers in an edge computing system.

FIG. 6 illustrates a compute and communication use case involving mobile access to applications in an edge computing system.

FIG. 7A provides an overview of example components for compute deployed at a compute node in an edge computing system.

FIG. 7B provides a further overview of example components within a computing device in an edge computing system.

FIG. 8 illustrates an example system implementing a centralized NN-based RRM optimization technique.

FIG. 9 illustrates an example model for a centralized NN-based RRM optimization technique.

FIG. 10 illustrates an example system implementing a distributed NN-based RRM optimization technique for downlink communications.

FIG. 11 illustrates an example model of a distributed policy maker for a distributed NN-based RRM optimization technique.

FIG. 12 illustrates example local operations that may take place between a TX and RX in a distributed NN-based RRM optimization technique for downlink communications.

FIG. 13 illustrates example global parameter update operations that may take place in a distributed NN-based RRM optimization technique for downlink communications.

FIG. 14 illustrates extended example local operations that may take place between a TX and RX in a distributed NN-based RRM optimization technique for downlink communications.

FIGS. 15-17 illustrate example simulation results comparing a centralized RRM optimization technique and different embodiments of a distributed RRM optimization technique.

FIG. 18 illustrates an example system implementing a distributed NN-based RRM optimization technique for uplink communications.

FIG. 19 illustrates example local operations that may take place between a TX and RX in a distributed NN-based RRM optimization technique for uplink communications.

FIG. 20 illustrates example global parameter update operations that may take place in a distributed NN-based RRM optimization technique for uplink communications.

FIG. 21 illustrates extended example local operations that may take place between a TX and RX in a distributed NN-based RRM optimization technique for uplink communications.

FIG. 22 illustrates an example system implementing a distributed NN-based RRM optimization technique in an ad-hoc network.

FIG. 23 illustrates example local operations that may take place between a TX and RX in a distributed NN-based RRM optimization technique for ad-hoc networks.

FIG. 24 illustrates example global parameter update operations that may take place in a distributed NN-based RRM optimization technique for ad-hoc networks.

FIG. 25 illustrates a set of pre-update operations 2500 that may be performed for a distributed NN-based RRM optimization technique.

FIG. 26 illustrates a set of post-update operations 2600 that may be performed for a distributed NN-based RRM optimization technique.

FIG. 27 illustrates extended example local operations that may take place between a TX and RX in a distributed NN-based RRM optimization technique for ad-hoc networks.

FIG. 28 illustrates another an example system implementing a distributed NN-based RRM optimization technique.

FIG. 29 illustrates example global parameter update operations for the system of FIG. 29.

FIG. 30 illustrates another an example system implementing a distributed NN-based RRM optimization technique.

### DETAILED DESCRIPTION

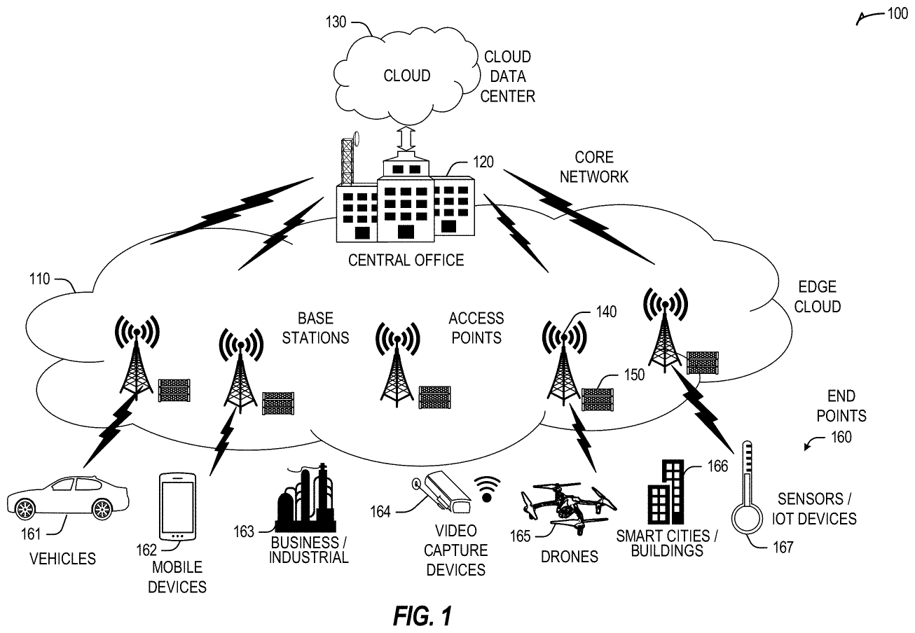

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data (e.g., at a “local edge”, “close edge”, or “near edge”). For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

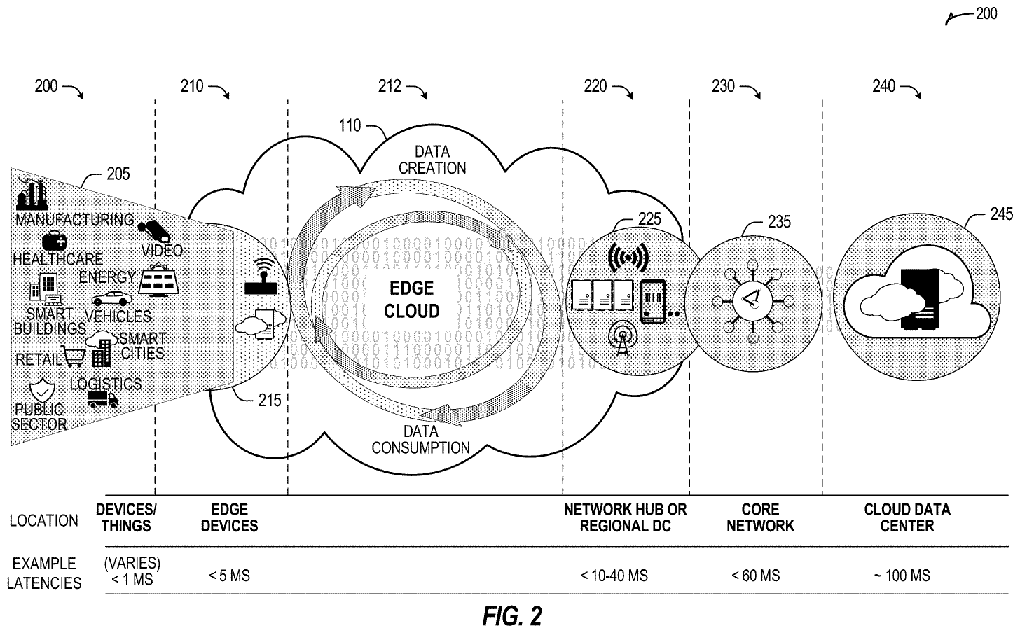

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premise servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210 (e.g., a “near edge” or “close edge” layer), to even between 10 to 40 ms when communicating with nodes at the network access layer 220 (e.g., a “middle edge” layer). Beyond the edge cloud 110 are core network 230 and cloud data center 240 layers, each with increasing latency (e.g., between 50-60 ms at the core network layer 230, to 100 or more ms at the cloud data center layer, both of which may be considered a “far edge” layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or slave role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

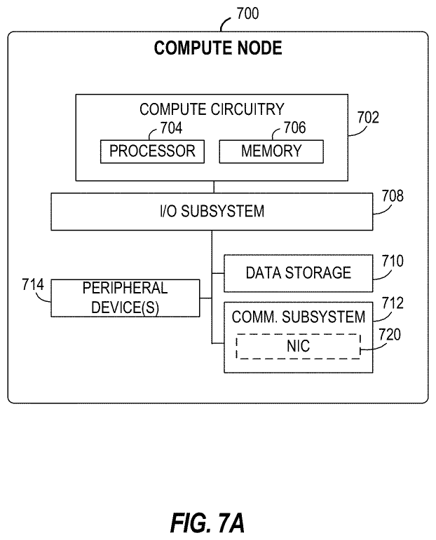

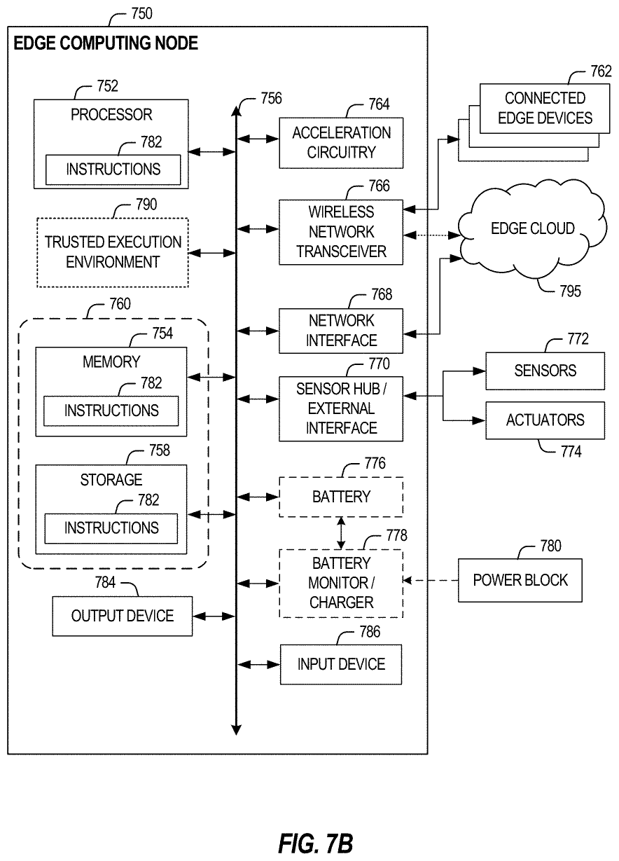

The network components of the edge cloud 110 may be servers, multi-tenant servers, appliance computing devices, and/or any other type of computing devices. For example, the edge cloud 110 may be an appliance computing device that is a self-contained processing system including a housing, case or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 7B. The edge cloud 110 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

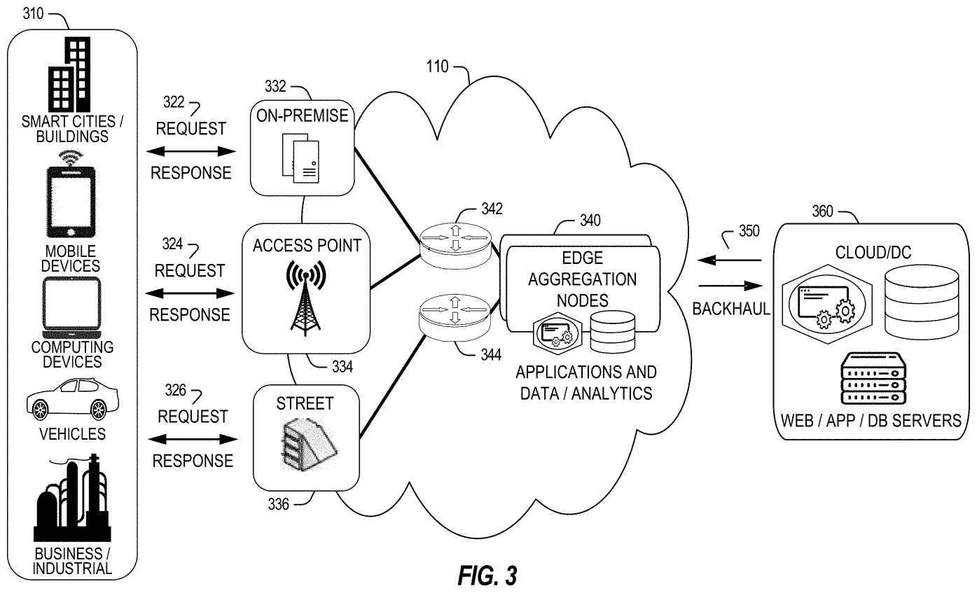

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premise network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

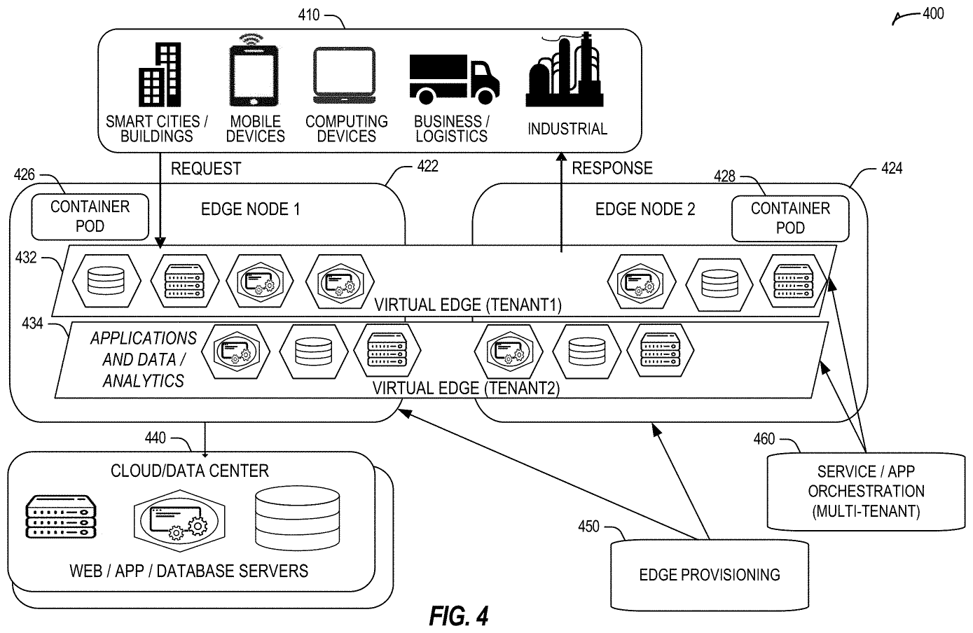

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the devices in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshaling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or, respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute and a different shared pod controller is installed and invoked prior to the second pod executing.

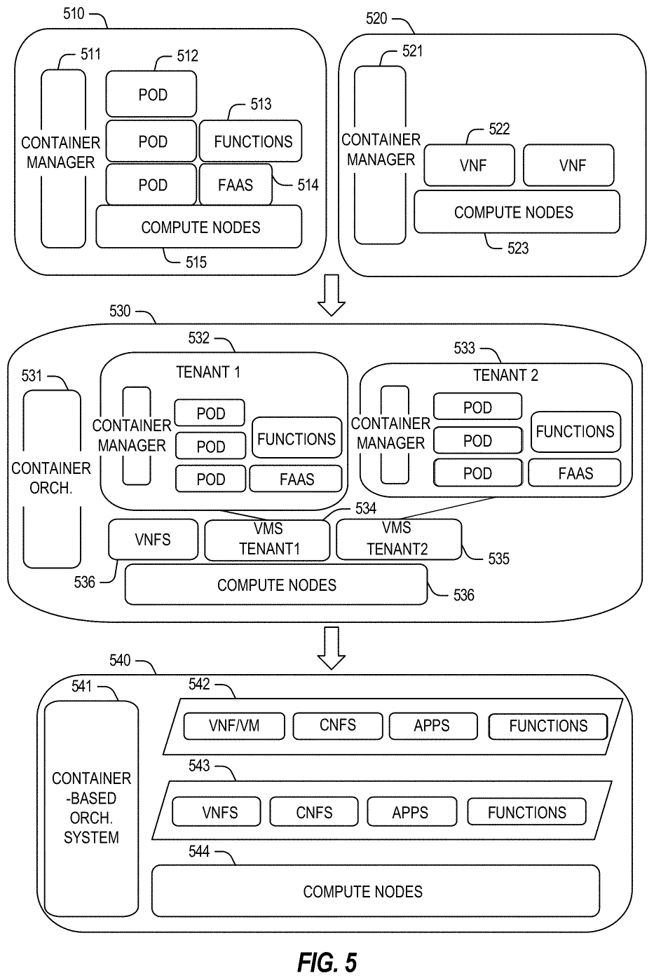

FIG. 5 illustrates additional compute arrangements deploying containers in an edge computing system. As a simplified example, system arrangements 510, 520 depict settings in which a pod controller (e.g., container managers 511, 521, and container orchestrator 531) is adapted to launch containerized pods, functions, and functions-as-a-service instances through execution via compute nodes (515 in arrangement 510), or to separately execute containerized virtualized network functions through execution via compute nodes (523 in arrangement 520). This arrangement is adapted for use of multiple tenants in system arrangement 530 (using compute nodes 536), where containerized pods (e.g., pods 512), functions (e.g., functions 513, VNFs 522, 536), and functions-as-a-service instances (e.g., FaaS instance 514) are launched within virtual machines (e.g., VMs 534, 535 for tenants 532, 533) specific to respective tenants (aside the execution of virtualized network functions). This arrangement is further adapted for use in system arrangement 540, which provides containers 542, 543, or execution of the various functions, applications, and functions on compute nodes 544, as coordinated by an container-based orchestration system 541.

The system arrangements of depicted in FIG. 5 provides an architecture that treats VMs, Containers, and Functions equally in terms of application composition (and resulting applications are combinations of these three ingredients). Each ingredient may involve use of one or more accelerator (FPGA, ASIC) components as a local backend. In this manner, applications can be split across multiple edge owners, coordinated by an orchestrator.

In the context of FIG. 5, the pod controller/container manager, container orchestrator, and individual nodes may provide a security enforcement point. However, tenant isolation may be orchestrated where the resources allocated to a tenant are distinct from resources allocated to a second tenant, but edge owners cooperate to ensure resource allocations are not shared across tenant boundaries. Or, resource allocations could be isolated across tenant boundaries, as tenants could allow “use” via a subscription or transaction/contract basis. In these contexts, virtualization, containerization, enclaves and hardware partitioning schemes may be used by edge owners to enforce tenancy. Other isolation environments may include: bare metal (dedicated) equipment, virtual machines, containers, virtual machines on containers, or combinations thereof.

In further examples, aspects of software-defined or controlled silicon hardware, and other configurable hardware, may integrate with the applications, functions, and services an edge computing system. Software defined silicon may be used to ensure the ability for some resource or hardware ingredient to fulfill a contract or service level agreement, based on the ingredient's ability to remediate a portion of itself or the workload (e.g., by an upgrade, reconfiguration, or provision of new features within the hardware configuration itself).

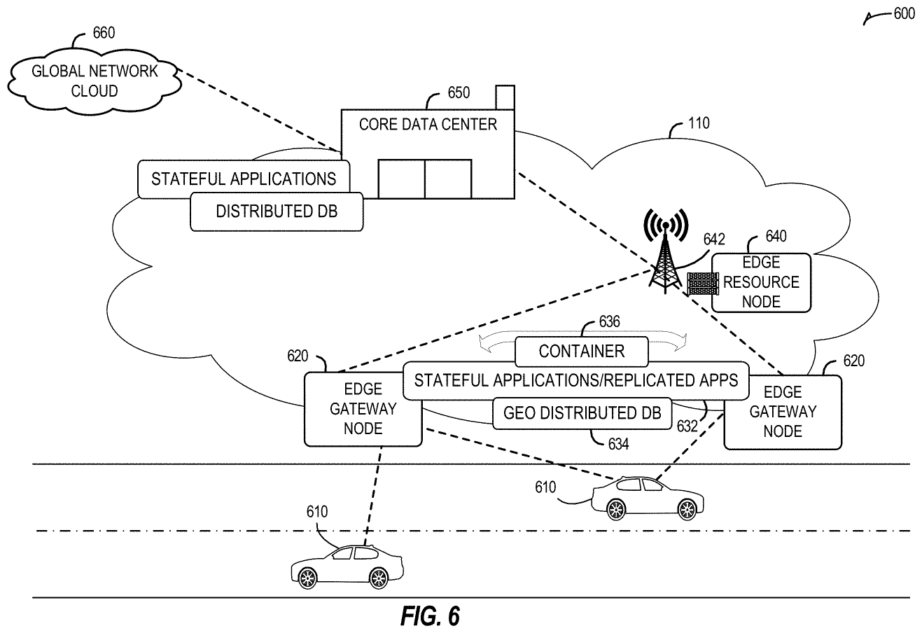

It should be appreciated that the edge computing systems and arrangements discussed herein may be applicable in various solutions, services, and/or use cases involving mobility. As an example, FIG. 6 shows a simplified vehicle compute and communication use case involving mobile access to applications in an edge computing system 600 that implements an edge cloud 110. In this use case, respective client compute nodes 610 may be embodied as in-vehicle compute systems (e.g., in-vehicle navigation and/or infotainment systems) located in corresponding vehicles which communicate with the edge gateway nodes 620 during traversal of a roadway. For instance, the edge gateway nodes 620 may be located in a roadside cabinet or other enclosure built-into a structure having other, separate, mechanical utility, which may be placed along the roadway, at intersections of the roadway, or other locations near the roadway. As respective vehicles traverse along the roadway, the connection between its client compute node 610 and a particular edge gateway device 620 may propagate so as to maintain a consistent connection and context for the client compute node 610. Likewise, mobile edge nodes may aggregate at the high priority services or according to the throughput or latency resolution requirements for the underlying service(s) (e.g., in the case of drones). The respective edge gateway devices 620 include an amount of processing and storage capabilities and, as such, some processing and/or storage of data for the client compute nodes 610 may be performed on one or more of the edge gateway devices 620.

The edge gateway devices 620 may communicate with one or more edge resource nodes 640, which are illustratively embodied as compute servers, appliances or components located at or in a communication base station 642 (e.g., a based station of a cellular network). As discussed above, the respective edge resource nodes 640 include an amount of processing and storage capabilities and, as such, some processing and/or storage of data for the client compute nodes 610 may be performed on the edge resource node 640. For example, the processing of data that is less urgent or important may be performed by the edge resource node 640, while the processing of data that is of a higher urgency or importance may be performed by the edge gateway devices 620 (depending on, for example, the capabilities of each component, or information in the request indicating urgency or importance). Based on data access, data location or latency, work may continue on edge resource nodes when the processing priorities change during the processing activity. Likewise, configurable systems or hardware resources themselves can be activated (e.g., through a local orchestrator) to provide additional resources to meet the new demand (e.g., adapt the compute resources to the workload data).

The edge resource node(s) 640 also communicate with the core data center 650, which may include compute servers, appliances, and/or other components located in a central location (e.g., a central office of a cellular communication network). The core data center 650 may provide a gateway to the global network cloud 660 (e.g., the Internet) for the edge cloud 110 operations formed by the edge resource node(s) 640 and the edge gateway devices 620. Additionally, in some examples, the core data center 650 may include an amount of processing and storage capabilities and, as such, some processing and/or storage of data for the client compute devices may be performed on the core data center 650 (e.g., processing of low urgency or importance, or high complexity).

The edge gateway nodes 620 or the edge resource nodes 640 may offer the use of stateful applications 632 and a geographic distributed database 634. Although the applications 632 and database 634 are illustrated as being horizontally distributed at a layer of the edge cloud 110, it will be understood that resources, services, or other components of the application may be vertically distributed throughout the edge cloud (including, part of the application executed at the client compute node 610, other parts at the edge gateway nodes 620 or the edge resource nodes 640, etc.). Additionally, as stated previously, there can be peer relationships at any level to meet service objectives and obligations. Further, the data for a specific client or application can move from edge to edge based on changing conditions (e.g., based on acceleration resource availability, following the car movement, etc.). For instance, based on the “rate of decay” of access, prediction can be made to identify the next owner to continue, or when the data or computational access will no longer be viable. These and other services may be utilized to complete the work that is needed to keep the transaction compliant and lossless.

In further scenarios, a container 636 (or pod of containers) may be flexibly migrated from an edge node 620 to other edge nodes (e.g., 620, 640, etc.) such that the container with an application and workload does not need to be reconstituted, re-compiled, re-interpreted in order for migration to work. However, in such settings, there may be some remedial or “swizzling” translation operations applied. For example, the physical hardware at node 640 may differ from edge gateway node 620 and therefore, the hardware abstraction layer (HAL) that makes up the bottom edge of the container will be re-mapped to the physical layer of the target edge node. This may involve some form of late-binding technique, such as binary translation of the HAL from the container native format to the physical hardware format, or may involve mapping interfaces and operations. A pod controller may be used to drive the interface mapping as part of the container lifecycle, which includes migration to/from different hardware environments.

The scenarios encompassed by FIG. 6 may utilize various types of mobile edge nodes, such as an edge node hosted in a vehicle (car/truck/tram/train) or other mobile unit, as the edge node will move to other geographic locations along the platform hosting it. With vehicle-to-vehicle communications, individual vehicles may even act as network edge nodes for other cars, (e.g., to perform caching, reporting, data aggregation, etc.). Thus, it will be understood that the application components provided in various edge nodes may be distributed in static or mobile settings, including coordination between some functions or operations at individual endpoint devices or the edge gateway nodes 620, some others at the edge resource node 640, and others in the core data center 650 or global network cloud 660.

In further configurations, the edge computing system may implement FaaS computing capabilities through the use of respective executable applications and functions. In an example, a developer writes function code (e.g., “computer code” herein) representing one or more computer functions, and the function code is uploaded to a FaaS platform provided by, for example, an edge node or data center. A trigger such as, for example, a service use case or an edge processing event, initiates the execution of the function code with the FaaS platform.

In an example of FaaS, a container is used to provide an environment in which function code (e.g., an application which may be provided by a third party) is executed. The container may be any isolated-execution entity such as a process, a Docker or Kubernetes container, a virtual machine, etc. Within the edge computing system, various datacenter, edge, and endpoint (including mobile) devices are used to “spin up” functions (e.g., activate and/or allocate function actions) that are scaled on demand. The function code gets executed on the physical infrastructure (e.g., edge computing node) device and underlying virtualized containers. Finally, container is “spun down” (e.g., deactivated and/or deallocated) on the infrastructure in response to the execution being completed.

Further aspects of FaaS may enable deployment of edge functions in a service fashion, including a support of respective functions that support edge computing as a service (Edge-as-a-Service or “EaaS”). Additional features of FaaS may include: a granular billing component that enables customers (e.g., computer code developers) to pay only when their code gets executed; common data storage to store data for reuse by one or more functions; orchestration and management among individual functions; function execution management, parallelism, and consolidation; management of container and function memory spaces; coordination of acceleration resources available for functions; and distribution of functions between containers (including “warm” containers, already deployed or operating, versus “cold” which require initialization, deployment, or configuration).

In further examples, any of the compute nodes or devices discussed with reference to the present edge computing systems and environment may be fulfilled based on the components depicted in FIGS. 7A and 7B. Respective edge compute nodes may be embodied as a type of device, appliance, computer, or other “thing” capable of communicating with other edge, networking, or endpoint components. For example, an edge compute device may be embodied as a smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 7A, an edge compute node 700 includes a compute engine (also referred to herein as “compute circuitry”) 702, an input/output (I/O) subsystem 708, data storage 710, a communication circuitry subsystem 712, and, optionally, one or more peripheral devices 714. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 700 may be embodied as any type of engine, device, or collection of devices capable of performing various compute functions. In some examples, the compute node 700 may be embodied as a single device such as an integrated circuit, an embedded system, a field-programmable gate array (FPGA), a system-on-a-chip (SOC), or other integrated system or device. In the illustrative example, the compute node 700 includes or is embodied as a processor 704 and a memory 706. The processor 704 may be embodied as any type of processor capable of performing the functions described herein (e.g., executing an application). For example, the processor 704 may be embodied as a multi-core processor(s), a microcontroller, or other processor or processing/controlling circuit. In some examples, the processor 704 may be embodied as, include, or be coupled to an FPGA, an application specific integrated circuit (ASIC), reconfigurable hardware or hardware circuitry, or other specialized hardware to facilitate performance of the functions described herein.

The memory 706 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 706 may be integrated into the processor 704. The memory 706 may store various software and data used during operation such as one or more applications, data operated on by the application(s), libraries, and drivers.

The compute circuitry 702 is communicatively coupled to other components of the compute node 700 via the I/O subsystem 708, which may be embodied as circuitry and/or components to facilitate input/output operations with the compute circuitry 702 (e.g., with the processor 704 and/or the main memory 706) and other components of the compute circuitry 702. For example, the I/O subsystem 708 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 708 may form a portion of a system-on-a-chip (SoC) and be incorporated, along with one or more of the processor 704, the memory 706, and other components of the compute circuitry 702, into the compute circuitry 702.

The one or more illustrative data storage devices 710 may be embodied as any type of devices configured for short-term or long-term storage of data such as, for example, memory devices and circuits, memory cards, hard disk drives, solid-state drives, or other data storage devices. Individual data storage devices 710 may include a system partition that stores data and firmware code for the data storage device 710. Individual data storage devices 710 may also include one or more operating system partitions that store data files and executables for operating systems depending on, for example, the type of compute node 700.

The communication circuitry 712 may be embodied as any communication circuit, device, or collection thereof, capable of enabling communications over a network between the compute circuitry 702 and another compute device (e.g., an edge gateway of an implementing edge computing system). The communication circuitry 712 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 712 includes a network interface controller (NIC) 720, which may also be referred to as a host fabric interface (HFI). The NIC 720 may be embodied as one or more add-in-boards, daughter cards, network interface cards, controller chips, chipsets, or other devices that may be used by the compute node 700 to connect with another compute device (e.g., an edge gateway node). In some examples, the NIC 720 may be embodied as part of a system-on-a-chip (SoC) that includes one or more processors, or included on a multichip package that also contains one or more processors. In some examples, the NIC 720 may include a local processor (not shown) and/or a local memory (not shown) that are both local to the NIC 720. In such examples, the local processor of the NIC 720 may be capable of performing one or more of the functions of the compute circuitry 702 described herein. Additionally, or alternatively, in such examples, the local memory of the NIC 720 may be integrated into one or more components of the client compute node at the board level, socket level, chip level, and/or other levels.

Additionally, in some examples, a respective compute node 700 may include one or more peripheral devices 714. Such peripheral devices 714 may include any type of peripheral device found in a compute device or server such as audio input devices, a display, other input/output devices, interface devices, and/or other peripheral devices, depending on the particular type of the compute node 700. In further examples, the compute node 700 may be embodied by a respective edge compute node (whether a client, gateway, or aggregation node) in an edge computing system or like forms of appliances, computers, subsystems, circuitry, or other components.

In a more detailed example, FIG. 7B illustrates a block diagram of an example of components that may be present in an edge computing node 750 for implementing the techniques (e.g., operations, processes, methods, and methodologies) described herein. This edge computing node 750 provides a closer view of the respective components of node 700 when implemented as or as part of a computing device (e.g., as a mobile device, a base station, server, gateway, etc.). The edge computing node 750 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 750, or as components otherwise incorporated within a chassis of a larger system.

The edge computing device 750 may include processing circuitry in the form of a processor 752, which may be a microprocessor, a multi-core processor, a multithreaded processor, an ultra-low voltage processor, an embedded processor, or other known processing elements. The processor 752 may be a part of a system on a chip (SoC) in which the processor 752 and other components are formed into a single integrated circuit, or a single package, such as the Edison™ or Galileo™ SoC boards from Intel Corporation, Santa Clara, Calif. As an example, the processor 752 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 752 and accompanying circuitry may be provided in a single socket form factor, multiple socket form factor, or a variety of other formats, including in limited hardware configurations or configurations that include fewer than all elements shown in FIG. 7B.

The processor 752 may communicate with a system memory 754 over an interconnect 756 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 758 may also couple to the processor 752 via the interconnect 756. In an example, the storage 758 may be implemented via a solid-state disk drive (SSDD). Other devices that may be used for the storage 758 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 758 may be on-die memory or registers associated with the processor 752. However, in some examples, the storage 758 may be implemented using a micro hard disk drive (HDD). Further, any number of new technologies may be used for the storage 758 in addition to, or instead of, the technologies described, such resistance change memories, phase change memories, holographic memories, or chemical memories, among others.

The components may communicate over the interconnect 756. The interconnect 756 may include any number of technologies, including industry standard architecture (ISA), extended ISA (EISA), peripheral component interconnect (PCI), peripheral component interconnect extended (PCIx), PCI express (PCIe), or any number of other technologies. The interconnect 756 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 756 may couple the processor 752 to a transceiver 766, for communications with the connected edge devices 762. The transceiver 766 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 762. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 766 (or multiple transceivers) may communicate using multiple standards or radios for communications at a different range. For example, the edge computing node 750 may communicate with close devices, e.g., within about 10 meters, using a local transceiver based on Bluetooth Low Energy (BLE), or another low power radio, to save power. More distant connected edge devices 762, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 766 (e.g., a radio transceiver) may be included to communicate with devices or services in the edge cloud 795 via local or wide area network protocols. The wireless network transceiver 766 may be a low-power wide-area (LPWA) transceiver that follows the IEEE 802.15.4, or IEEE 802.15.4g standards, among others. The edge computing node 750 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 766, as described herein. For example, the transceiver 766 may include a cellular transceiver that uses spread spectrum (SPA/SAS) communications for implementing high-speed communications. Further, any number of other protocols may be used, such as Wi-Fi® networks for medium speed communications and provision of network communications. The transceiver 766 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 768 may be included to provide a wired communication to nodes of the edge cloud 795 or to other devices, such as the connected edge devices 762 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 768 may be included to enable connecting to a second network, for example, a first NIC 768 providing communications to the cloud over Ethernet, and a second NIC 768 providing communications to other devices over another type of network.

Given the variety of types of applicable communications from the device to another component or network, applicable communications circuitry used by the device may include or be embodied by any one or more of components 764, 766, 768, or 770. Accordingly, in various examples, applicable means for communicating (e.g., receiving, transmitting, etc.) may be embodied by such communications circuitry.

The edge computing node 750 may include or be coupled to acceleration circuitry 764, which may be embodied by one or more artificial intelligence (AI) accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like.

The interconnect 756 may couple the processor 752 to a sensor hub or external interface 770 that is used to connect additional devices or subsystems. The devices may include sensors 772, such as accelerometers, level sensors, flow sensors, optical light sensors, camera sensors, temperature sensors, global navigation system (e.g., GPS) sensors, pressure sensors, barometric pressure sensors, and the like. The hub or interface 770 further may be used to connect the edge computing node 750 to actuators 774, such as power switches, valve actuators, an audible sound generator, a visual warning device, and the like.

In some optional examples, various input/output (I/O) devices may be present within or connected to, the edge computing node 750. For example, a display or other output device 784 may be included to show information, such as sensor readings or actuator position. An input device 786, such as a touch screen or keypad may be included to accept input. An output device 784 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 750. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 776 may power the edge computing node 750, although, in examples in which the edge computing node 750 is mounted in a fixed location, it may have a power supply coupled to an electrical grid, or the battery may be used as a backup or for temporary capabilities. The battery 776 may be a lithium ion battery, or a metal-air battery, such as a zinc-air battery, an aluminum-air battery, a lithium-air battery, and the like.

A battery monitor/charger 778 may be included in the edge computing node 750 to track the state of charge (SoCh) of the battery 776, if included. The battery monitor/charger 778 may be used to monitor other parameters of the battery 776 to provide failure predictions, such as the state of health (SoH) and the state of function (SoF) of the battery 776. The battery monitor/charger 778 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 778 may communicate the information on the battery 776 to the processor 752 over the interconnect 756. The battery monitor/charger 778 may also include an analog-to-digital (ADC) converter that enables the processor 752 to directly monitor the voltage of the battery 776 or the current flow from the battery 776. The battery parameters may be used to determine actions that the edge computing node 750 may perform, such as transmission frequency, mesh network operation, sensing frequency, and the like.

A power block 780, or other power supply coupled to a grid, may be coupled with the battery monitor/charger 778 to charge the battery 776. In some examples, the power block 780 may be replaced with a wireless power receiver to obtain the power wirelessly, for example, through a loop antenna in the edge computing node 750. A wireless battery charging circuit, such as an LTC4020 chip from Linear Technologies of Milpitas, Calif., among others, may be included in the battery monitor/charger 778. The specific charging circuits may be selected based on the size of the battery 776, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 758 may include instructions 782 in the form of software, firmware, or hardware commands to implement the techniques described herein. Although such instructions 782 are shown as code blocks included in the memory 754 and the storage 758, it may be understood that any of the code blocks may be replaced with hardwired circuits, for example, built into an application specific integrated circuit (ASIC).

In an example, the instructions 782 provided via the memory 754, the storage 758, or the processor 752 may be embodied as a non-transitory, machine-readable medium 760 including code to direct the processor 752 to perform electronic operations in the edge computing node 750. The processor 752 may access the non-transitory, machine-readable medium 760 over the interconnect 756. For instance, the non-transitory, machine-readable medium 760 may be embodied by devices described for the storage 758 or may include specific storage units such as optical disks, flash drives, or any number of other hardware devices. The non-transitory, machine-readable medium 760 may include instructions to direct the processor 752 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 782 on the processor 752 (separately, or in combination with the instructions 782 of the machine readable medium 760) may configure execution or operation of a trusted execution environment (TEE) 790. In an example, the TEE 790 operates as a protected area accessible to the processor 752 for secure execution of instructions and secure access to data. Various implementations of the TEE 790, and an accompanying secure area in the processor 752 or the memory 754 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 750 through the TEE 790 and the processor 752.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Federated Learning for Radio Resource Management

Aspects of the present disclosure may apply Federated Machine Learning (ML) training methods for multi-cellular Radio Resource Management (RRM). The federated learning (FL) approaches described herein may implement an on-device, on-line RRM training method, which not only adapts the learning according to the changing environment, but also avoids the resource-intensive exchange of channel state information between the clients and the network. For instance, a distributed approach may be implemented in certain embodiments, wherein edge devices locally learn the resource allocation policy (e.g., power allocation policy) and exchange these local policy recommendations with the network. The network then combines these local recommendations to determine an overall policy. Simulation results show that these policy recommendations can be exchanged with significantly reduced frequency as compared to the regular reporting of channel state information, which may be required for traditional centralized approaches, without significant impact on performance. In particular embodiments, a centralized ML-based approach is implemented, which may include training a Neural-Network (NN) via a primal-dual-training to operate in a distrusted/federated setting. There may be many solutions for multi-cellular radio resource management, as the optimal solution is difficult to solve. However, ML tools have recently been applied successfully to enhance the performance of such solutions.

In current NN-based solutions, the NN may be centralized and it is assumed that the channel state (CSI) measurements from all receivers from the network are collected at a central node to enable the central node (CN) to make decisions on the RRM policy, which executes within that the coherence time of the network. The CN then forwards the policy/decision to all transmitters and receivers in the network. However, if the coherence time is too short (e.g., due to high mobility), the channel may change by the time the fully central solution reaches to transmitters and receivers, making the decision invalid. Further, such a central solution relies on extensive CSI reporting, which does not scale in communication and in computation as the geographical area of implementation gets wider, or as nodes enter/exit the network.

Instead of having an RRM decision structure for whole network in a central node as in current systems, embodiments of the present disclosure propose to have an individual RRM decision substructure for each link on the device side (either as transmitter or receiver) so that both inference and training of local parameters can continue at the edge device, based on new channel measurements, in an on-line manner. Aspects of the present disclosure may operate with a distributed decoupled NN structure and introduce interim optimization parameters, and may allow for a gradient update frequency of optimization parameters to be tuned for available bandwidth of the CN and the desired performance. The step size of these parameters can be adjusted depending on the update period. Furthermore, our proposed methods can easily be extended to ad-hoc networks as well as operate at higher layer of the communication stack.

In certain embodiments of the present disclosure, devices with heterogeneous computation capabilities may be allowed to develop an RRM solution in a federated manner, allowing for reduced feedback as well online solution approaches, which can adapt better to local conditions, unlike a centralized solution framework as in current NN-based systems. Furthermore, more powerful clients can make better decisions (e.g., with deeper local neural networks (NNs)).

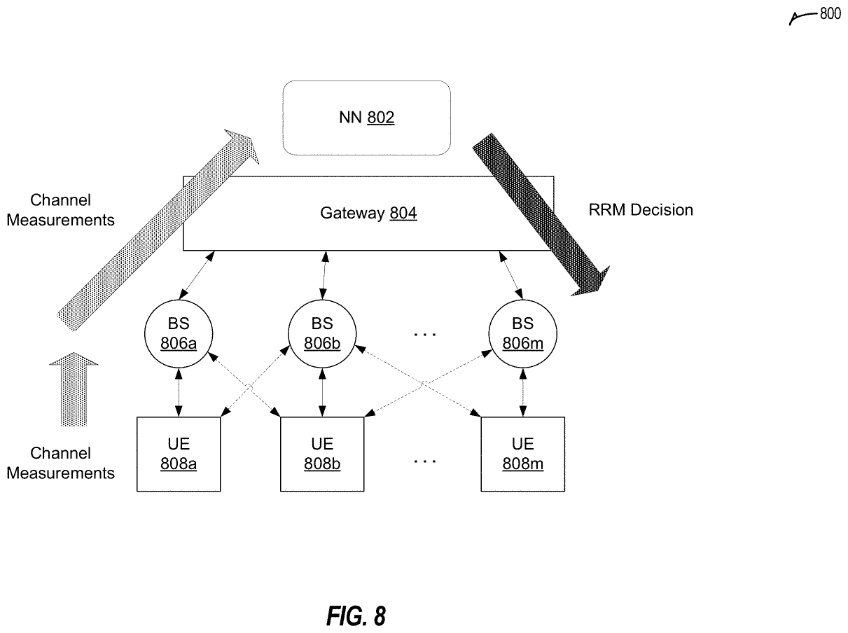

FIG. 8 illustrates an example system 800 implementing a centralized NN-based RRM optimization technique. As shown in FIG. 8 and described above, channel measurements and RRM decisions may need to be exchanged as often as once in a channel coherence period for centralized techniques. As such, this framework may be sensitive to the latency in the backhaul. For instance, in the example system 800, channel measurements are sent from user equipment devices (UEs) 808 through the base stations (BS) 806 and gateway 804 to a centralized NN 802. The centralized NN 802 may exist at the gateway 804 or in another central node above the gateway 804 in the network architecture. The centralized NN 802 may utilize the channel measurements as inputs to arrive at RRM decisions for the BS-UE links. The RRM decisions may be passed down to the BS 806, which may implement such decisions. However, as described above, channel measurements or other conditions may change during this time, causing potentially non-optimal RRM.

As one can observe, FIG. 8 may represent a framework to realize the algorithm above and just like any other feasible realization, however, it requires the exchange of channel measurements over the wireless link and the backhaul for both training and inference. Accordingly, the channel measurements need to be exchanged whenever they are obtained, which may be problematic for the reasons previously described. As one example, the channel conditions may have changed by the time any RRM decision is made by the central NN 802.

Accordingly, in embodiments of the present disclosure, instead of having a central NN (e.g., 802), multiple “local” NNs may be utilized that are local to the links for which the RRM decision is to be made (e.g., an NN in the UE or an NN in the AP/BS. Optimization parameters are defined that capture interference or other channel measurements between UEs, APs, etc. These optimization parameters may be shared amongst the NNs in the system instead of the channel measurements as in the system of FIG. 8. This is beneficial because the optimization parameters are smaller than the channel measurements matrix, so less data is exchanged over the network.

In particular embodiments, a primal-dual optimization problem may be defined for certain RRM decisions, e.g., a transmit power for a TX, that includes primal variables (e.g., θ and x described further below), and dual variables (e.g., [symbol] and [symbol] described further below), similar to previous RRM optimization approaches. However, the present disclosure provides for a new primal variable (e.g., ρ as described further below) that represents an expected power output of a transmitter and a corresponding dual variable (e.g., ν as described further below) that represents how sensitive a receiver is to other transmitters.

A number of local updates may be performed on the local NNs (e.g., at the UE or AP/BS). Each local update operation keeps the global primal variable (ρ) and global dual variable (ν) constant (e.g., from previous iterations), and the local update operations may be performed multiple times to make a corresponding number of RRM decisions (e.g., transmit power) (ρ). Function estimates may be updated in certain instances during the local update operations (e.g., can be done for more powerful devices and not done for less powerful devices). The local update operations may be performed to update the local primal variables (e.g., θ and x described further below) and local dual variables (e.g., [symbol] and [symbol] described further below) of the optimization problem based on channel measurements obtained by the local NN for link(s) between the device hosting the NN and other nodes of the system.

As used herein, channel measurements may refer to a measurement of the condition of a wireless channel between a transmitter (TX) and receiver (RX) (e.g., between an AP/BS and UE). Channel measurements can include, for example, channel quality information, channel state information, received signal strength, signal-to-noise ratio, time-delay, phase difference between TX & RX. The channel measurements can be per-antenna, per-port, or per-device. The channel measurements may be in the form of a set of scalars, a vector, or a matrix for a single TX-RX pair. The channel measurement values can be real or complex. For the sake of explanation, in examples described herein, it is assumed that the channel measurements values are real scalar values.

After some number of local update operation rounds, the global primal variable (ρ) may be updated and sent to a gateway node (e.g., a central node in the system). The updated global primal variables (ρ) may also be exchanged with the other local NNs of the system as well. The gateway may update the global dual variables (ν) based on the updated global primal variables (ρ) received from each local NN, and may transmit the updated global dual variables (ν) to each of the local NNs of the system, which can then use the updated global primal variables (ρ) and global dual variables (ν) to perform additional rounds of local update operations.

Primal and dual parameters can be interpreted as follows: one of them is the value of average power a node expects other communication links should communicate with, and the other one is what the node believes other nodes would expect from the node when it communicates between its TXi & RXi. Which one is considered “primal” and which one is considered “dual” may depend on how the problem is formulated (one example is described in further detail below). Accordingly, there may be a unique set of primal & dual parameters for every link-pair, or every TXj-RXi pair, whether there is a communication link between them or not. And each of primal/dual parameters for single TXj-RXi pair are (assumed to be real scalar, but for the sake of completeness they can also be) complex & vector.

Power Management in Cellular Downlink Channel

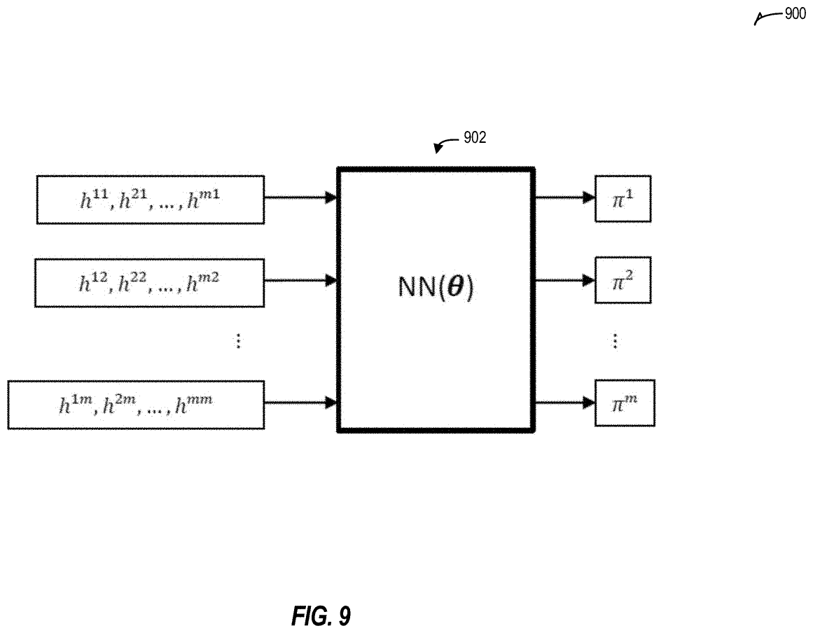

Legacy power control solutions in cellular downlink channels are based on desired signal-to-noise ratio (SNR) at the user equipment (UE), which is the receiver (RX) of the downlink data communication. They usually do not consider the interference they will hear from other base stations (BS) or the interference they will cause to neighboring UEs. In centralized solutions such as the one shown in FIG. 8, RRM decisions can be made with a ML-based policy maker at a central node (CN) (e.g., gateway 804). RRM problems of this sort may be formulated as follows:

$${P}_{θ}^{*} := {max}_{θ , x ∈ χ} {\sum }_{i = 1}^{m} {w}^{i} {x}^{i}$$

$$s . t . {x}^{i} \leq {E}_{H} [ log ( 1 + \frac{{h}^{ii} {π}^{i} ( H , θ )}{{\sum }_{j \neq i} {h}^{ij} {π}^{j} ( H , θ ) + {N}^{i}} ) ] , ∀ i$$

$${E}_{H} [ {π}^{i} ( H , θ ) ] \leq {p}_{max}^{i} ∀ i$$

where H=[h¹, h², . . . , h^{m}], hⁱ=[h¹ⁱ, . . . , h^{ji}, . . . , h^{mi}]^{T} is the vector of channel gains from all TXs to RXi, with h^{ji} representing the channel gain from TXj to RXi, θ is the vector of parameters representing the policy maker, πⁱ(H, θ) is the power decision for TXi, xⁱ is the achievable throughput of link i, wⁱ is the weight of link i in the total network utility, and pₘₐₓⁱ is the constant representing the maximum power constraint on the TX. The policy maker may be a neural network (NN) modeled as shown in FIG. 9. In the example NN system 900 shown in FIG. 9, the NN 902 receives the vectors h^{ji} described above and produces the vector of parameters πⁱ(H, θ) described above.

Introducing Lagrange variables to the optimization problem and alternating updates on primal and dual variables provides an online and adaptive algorithm for both learning and inferring a power policy. In some embodiments, for example, the min-max problem may be given as:

$${D}_{θ}^{*} := {min}_{λ , μ} {max}_{θ , x} {\sum }_{i = 1}^{m} {w}^{i} {x}^{i} + {\sum }_{i = 1}^{m} {λ}^{i} ( {F}^{i} ( {h}^{i} , π ( H , θ ) ) - {x}^{i} ) - {\sum }_{i}^{m} {μ}^{i} ( {G}^{i} ( {π}^{i} ( H , {θ}^{i} ) ) - {p}_{max}^{i} )$$

where

$${F}^{i} ( {h}^{i} , π ( H , θ ) ) = {E}_{H} [ log ( 1 + \frac{{h}^{ii} {π}^{i} ( H , θ )}{{\sum }_{j \neq i} {h}^{ji} {π}^{j} ( H , θ ) + {N}^{i}} ) ] , \\ {G}^{i} ( {π}^{i} ( H , θ ) ) = {E}_{H} [ {π}^{i} ( H , θ ) ] ,$$

and λⁱ and μⁱ are Lagrange variables corresponding to constraints in the optimization problem.

Then, alternating updates may be implemented as follows:

θₖ₊₁=θₖ +γ_{θ,k} [λₖⁱ∇_{θ}Fⁱ (hₖⁱ, π(Hₖ, θₖ))−μₖⁱ∇_{θ}Gⁱ (πⁱ(Hₖ, θₖ))]

xₖ₊₁ⁱ=P_{X}[xₖⁱ+γ_{x,k}(wⁱ−λₖⁱ)]

λₖ₊₁ⁱ=[λₖⁱ−γ_{λ,k} (\hat{F}ⁱ (hₖⁱ, π(Hₖ, θₖ₊₁))−xₖ₊₁ⁱ)]₊

μₖ₊₁ⁱ=[μₖⁱ+γ_{μ,k} (Ĝⁱ (π¹(Hₖ, θₖ₊₁))−pₘₐₓⁱ)]₊

where P_{X}[.] represents projection to the convex set of rates supported by available MCS schemes and [.]₊ represents projection to non-negative real numbers. γ_{.,k} is the learning rate for the given variable at iteration k.

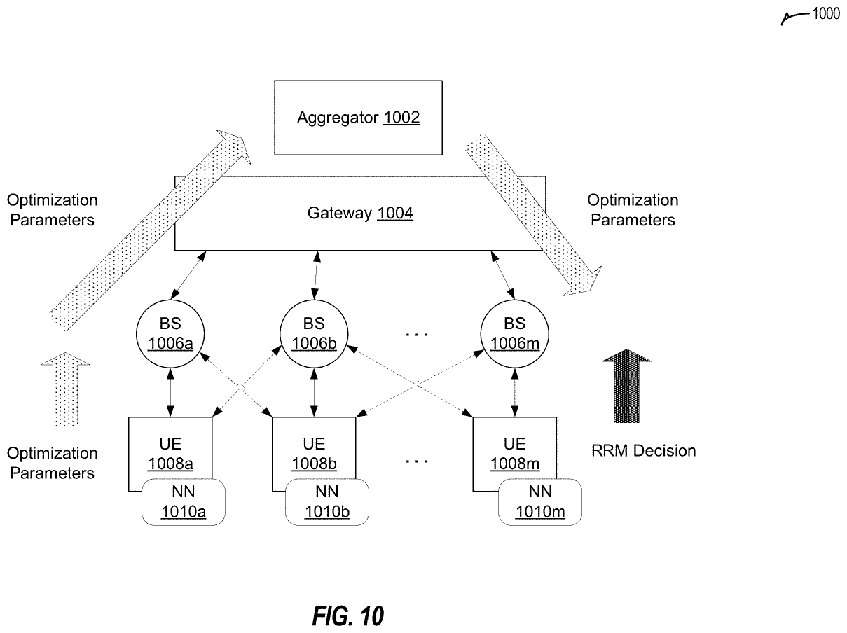

FIG. 10 illustrates an example system 1000 implementing a distributed NN-based RRM optimization technique for downlink communications. UEs may be considered as RXs of the network and the BSs may be considered as transmitters (TX) in the downlink example. Each TXi wirelessly sends data to RXi while interfering to RXj (∀j≠i). Therefore, a transmit power decision of a TXi affects the throughput at RXj as well as the throughput at RXi. All TXs are also connected via a backhaul network and communicate with one another (e.g., through an X2 interface). Accordingly, they can share control signals.

In the example shown, the system architecture is similar to that of FIG. 8, except that each UE (RX) 1008 implements its own NN 1010. The UEs 1008 generate optimization parameters that are distributed to the BS 1006, gateway 1004, aggregator 1002, and other UEs 1008 through the backhaul. The NNs 1010 may in turn utilize the shared optimization parameters to arrive at RRM decisions. The optimization parameters may be shared, in some cases, as often as once in a channel coherence period. These optimization parameters may utilize less bandwidth than the channel measurements described above, and accordingly may provide one or more advantages over centralized RRM optimization techniques. While RRM decisions may be exchanged often, they will not need to be exchanged over the backhaul as in the techniques described above, e.g., with respect to FIG. 8.

Problem Relaxation and the Distributed Solution

In order to distribute the algorithm, we first modify the NN structure described above with respect to FIGS. 8-9. In particular, a NN-based decision maker may be designated for each link, i.e., there may be separate neural networks (NN) for each BS-UE link as shown in FIG. 10. Although illustrated in FIG. 10 as being at the UE, the NNs may be located at BS in certain embodiments so that inference can happen whenever channel measurements are taken.

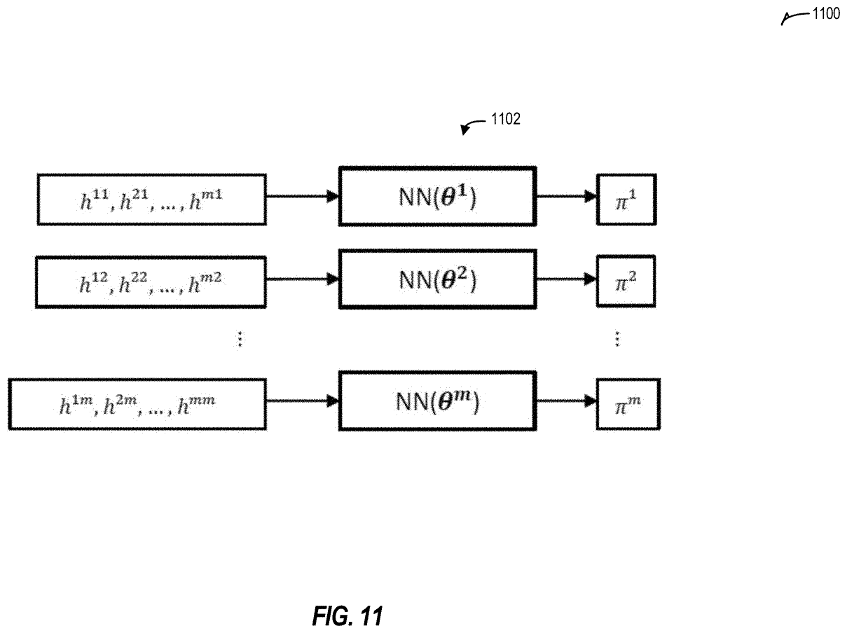

FIG. 11 illustrates an example model 1100 of a distributed policy maker for a distributed NN-based RRM optimization technique. In the example shown, each respective distributed NN 1102 receives the vectors h^{ji} and produces the vector of parameters πⁱ(H, θ). Under this new structure, the optimization problem may be as follows:

$${P}_{θ}^{*} := {max}_{θ , x ∈ χ} {\sum }_{i = 1}^{m} {w}^{i} {x}^{i}$$

$$s . t . {x}^{i} \leq {E}_{h} [ log ( 1 + \frac{{h}^{ii} {π}^{i} ( {h}^{i} , {θ}^{i} )}{{\sum }_{j \neq i} {h}^{ji} {π}^{j} ( {h}^{j} , {θ}^{j} ) + {N}^{i}} ) ] , ∀ i$$

$${E}_{{h}^{i}} [ {π}^{i} ( {h}^{i} , {θ}^{i} ) ] \leq {p}_{max}^{i} ∀ i$$

To decouple the interference, the problem may be further relaxed by introducing a new set of variables, ρ^{ij}, representing the maximum expected transmit power allowed for TXj by RXi when i≠j. Then the problem may become as follows:

$${P}_{θ}^{*} := {max}_{θ , x , ρ ∈ χ} {\sum }_{i = 1}^{m} {w}^{i} {x}^{i}$$

$$s . t . {x}^{i} \leq {E}_{{h}^{i}} [ log ( 1 + \frac{{h}^{ii} {π}^{i} ( {h}^{i} , {θ}^{i} )}{{\sum }_{j \neq i} {h}^{ji} {ρ}^{ji} + {N}^{i}} ) ] , ∀ i$$

$${E}_{{h}^{i}} [ {π}^{i} ( {h}^{i} , {θ}^{i} ) ] \leq {p}_{max}^{i} , ∀ i$$

$${E}_{{h}^{j}} [ {π}^{j} ( {h}^{j} , {θ}^{j} ) ] \leq {ρ}^{ji} , ∀ i , j \neq i$$

Lagrange variables and alternating update of primal and dual parameters may be introduced, similar to the centralized technique described above, as follows:

$${D}_{θ}^{*} := {min}_{λ , μ , v} {max}_{θ , x , P} {\sum }_{i = 1}^{m} {w}^{i} {x}^{i} + {\sum }_{i = 1}^{m} {λ}^{i} ( {F}^{i} ( {h}^{i} , {π}^{i} ( {h}^{i} , {θ}^{i} ) , {ρ}^{i} ) - {x}^{i} ) - {\sum }_{i}^{m} {μ}^{i} ( {G}^{i} ( {π}^{i} ( {h}^{i} , {θ}^{i} ) ) - {p}_{max}^{i} ) - {\sum }_{j}^{m} {\sum }_{i \neq j}^{m} {v}^{ji} ( {G}^{j} ( {π}^{j} ( {h}^{j} , {θ}^{j} ) ) - {ρ}^{ji} )$$

where

$${F}^{i} ( {h}^{i} , {π}^{i} ( {h}^{i} , {θ}^{i} ) {ρ}^{i} ) = {E}_{{h}^{i}} [ log ( 1 + \frac{{h}^{ii} {π}^{i} ( {h}^{i} , {θ}^{i} )}{{\sum }_{j \neq i} {h}^{ji} {ρ}^{ji} + {N}^{i}} ) ] , \\ and {G}^{i} ( {π}^{i} ( {h}^{i} , {θ}^{i} ) ) = {E}_{{h}^{i}} [ {π}^{i} ( {h}^{i} , {θ}^{i} ) ] .$$

The update may accordingly become as follows:

$${θ}_{k + 1}^{i} = {θ}_{k}^{i} + {γ}_{θ , k} [ {λ}_{k}^{i} {∇}_{{θ}^{i}} {F}^{i} ( {h}_{k}^{i} , {π}^{i} ( {h}_{k}^{i} , {θ}_{k}^{i} ) , {ρ}_{k}^{i} ) - {μ}_{k}^{i} {∇}_{{θ}^{i}} {G}^{i} ( {π}^{i} ( {h}_{k}^{i} , {θ}_{k}^{i} ) ) - {\sum }_{j \neq i} {v}_{k}^{ij} {∇}_{{θ}^{i}} {G}^{i} ( {π}^{i} ( {h}_{k}^{i} , {θ}_{k}^{i} ) ) ]$$

$${x}_{k + 1}^{i} = {P}_{x} [ {x}_{k}^{i} + {γ}_{x , k} ( {w}^{i} - {λ}_{k}^{i} ) ]$$

$${ρ}_{k + 1}^{ji} = {[ {ρ}_{k}^{ji} + {γ}_{P , k} [ {λ}_{k}^{i} {∇}_{{ρ}^{ji}} {F}^{i} ( {h}_{k}^{i} , {π}^{i} ( {h}_{k}^{i} , {θ}_{k}^{i} ) , {ρ}_{k}^{i} ) + {v}_{k}^{ji} ] ]}_{+}$$

As long as the policy maker (NN) i has access to ρⁱ=, [ρ¹ⁱ, . . . , ρ^{ji}, . . . , ρ^{mi}]^{T} and [νⁱ¹, . . . , ν^{ij}, . . . , ν^{im}], it can update θₖ₊₁ⁱ, xₖ₊₁ⁱ, λₖ₊₁ⁱ, and μₖ₊₁ⁱ locally without need of information exchange. Therefore, the primal parameters (θⁱ, xⁱ) and dual parameters (λⁱ, μⁱ) parameters may be considered as local parameters in this example. However, to update ρₖ₊₁^{ji} and νₖ₊₁^{ij}, information may need to be exchanged between other policy makers (NNs 1102). Accordingly, ρⁱ and νⁱ may be considered global parameters, which need to be exchanged between BSs. For example, the link i may store the information about how much TX power it anticipates seeing from the transmitters interfering to RXi (ρₖ₊₁^{ji}) as well as how much the receivers anticipate seeing interference from TXi (νₖ₊₁^{ij}) to determine the power decision for link i.

Since it can take longer time for the exchange between the policy makers, it can happen less frequently, meaning that, updates of the local parameters θₖ₊₁ⁱ, xₖ₊₁ⁱ, λₖ₊₁ⁱ, and μₖ₊₁ⁱ can happen immediately after a new set of channel measurements are taken whereas the updates of the global parameters ρₖ₊₁^{ji} and νₖ₊₁^{ij} can happen less often. Keeping the NN parameters local may help the inference to happen more quickly, and for training on these parameters to happen as fast as an arrival rate of channel measurements.

Proposed Framework for Downlink Control

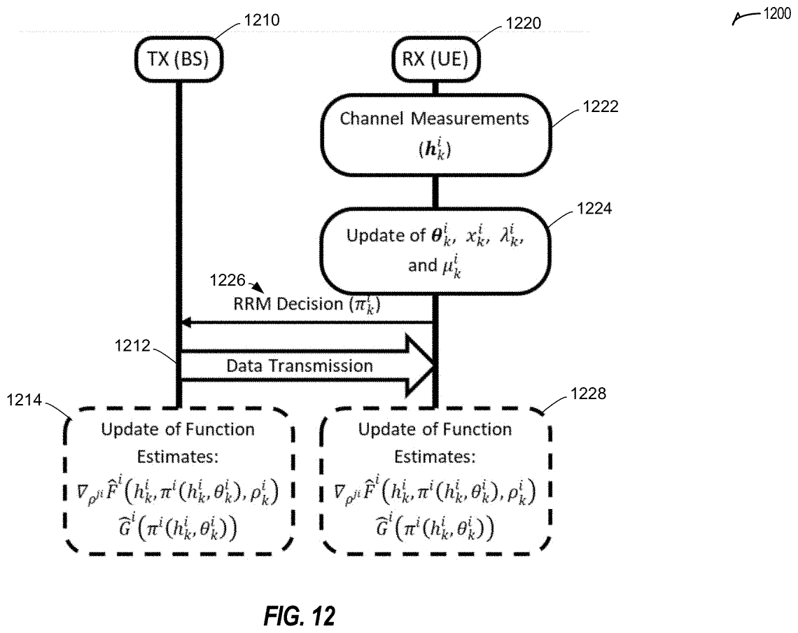

FIG. 12 illustrates example local operations 1200 that may take place between a TX and RX in a distributed NN-based RRM optimization technique for downlink communications. For the distributed algorithm described above, a control signaling framework as shown in FIG. 12 may be implemented between TX 1210 (BS for downlink) and RX 1220 (UE for downlink) in a pair and between TXs (BSs). As shown in FIG. 12, once the RX 1220 measures the current channel at 1222 and obtains channel measurements hₖⁱ, it updates local parameters (θₖⁱ, xₖⁱ, λₖⁱ, and μₖⁱ) locally at 1224 using the NN at the RX 1220. The RX 1220 then retrieves the policy decision (πₖⁱ) made on the NN and forwards it to the TX 1210 (BS) at 1226. Data can then be transmitted at 1212 at the power level decided by the NN (i.e., based on the policy decision (πₖⁱ)).

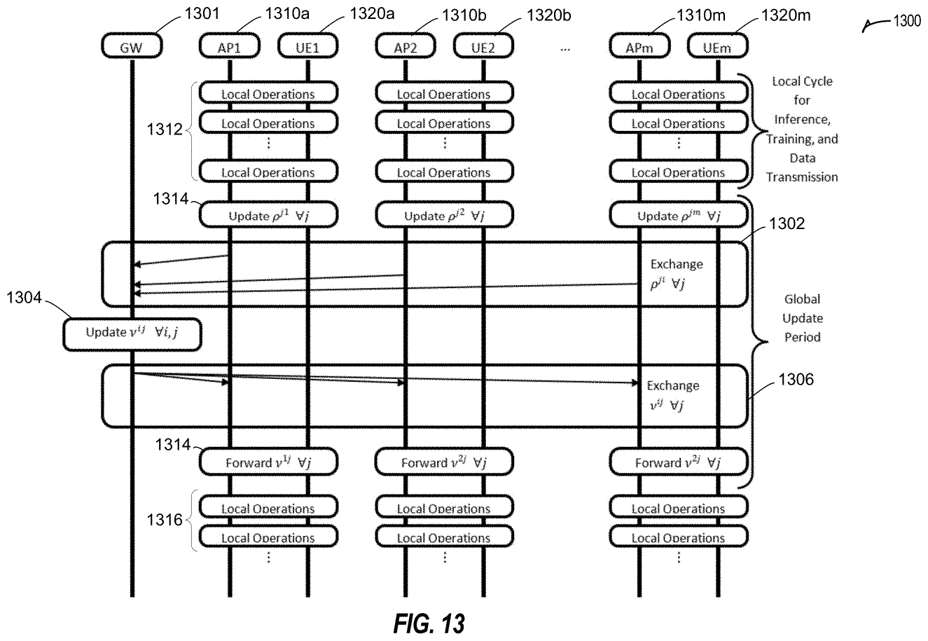

After the data transmission at 1212, the estimates of functions may be used in the update of the global parameters (πₖ^{ji} and νₖ^{ij}) at 1214, 1228 by the TX 1210 and RX 1220, respectively. Even though these global parameters are not necessarily updated at every iteration, functions required for their update include estimates of expectations over channel instances, which can be updated at every new channel observation locally. Depending on the availability of the required information and the computation capabilities, these estimations can be calculated at either the TX/BS side or RX/UE side. For the following discussion, the local signaling and local calculations shown in FIG. 12 may be referred to as “local operations”. The local operations shown in FIG. 12 may be repeated a number of times until the next global update, which is described below with reference to FIG. 13.

FIG. 13 illustrates example global parameter update operations 1300 that may take place in a distributed NN-based RRM optimization technique for downlink communications. In particular, FIG. 13 illustrates example information that may be exchanged between BSs during the global parameter update process. In the downlink power control problem, global parameters ρₖ^{ji} and νₖ^{ij} are kept in BSi or UEi, ∀j. However, the update of ρₖ₊₁^{ji} requires νₖ^{ji}, which may not be present at BSi, and the update of νₖ₊₁^{ij} requires ρₖ₊₁^{ij}, which may not be present at BSi. Therefore, these parameters may be exchanged immediately after their update. Because of the primal-dual update technique described herein, the global update period may include one update and exchange of primal parameters and one update and exchange of dual parameters. After these exchanges, local operations can continue again. However, during global exchanges, the step of updating local parameters can be skipped in the local operations. One advantage of having such a framework is that it may allow faster inference because NN parameters (θⁱ) and inputs (hⁱ) are local and that training on NN parameters can continue as new data arrives.

In the example shown in FIG. 13, each access point (AP) 1310 (which may be, e.g., a BS as in the previous example) and UE 1320 pair first performs local operations 1312 to update local primal and dual parameters for a NN-based model. In some embodiments, the local operations 1312 may include the operations described above with respect to FIG. 12. The local operations 1312 may be performed a number of times as shown.

After some amount of time or a particular number of local operations being performed, the global parameters ρₖ^{ji} are updated between the AP-UE pair at 1314, and then the global parameters ρₖ^{ji} are exchanged with a central gateway (GW) 1301 at 1302 by the APs 1310. In some embodiments, the central gateway 1301 may be located away from the edge, such as in central office 120 or cloud 130 of FIG. 1, cloud 360 of FIG. 3, or core data center 650 or cloud 660 of FIG. 6, for example. The gateway 1301 uses the global parameters ρₖ^{ji} to update the global parameters νₖ^{ij} at 1304, and then exchanges the global parameters νₖ^{ij} with the APs 1310 at 1306. The APs 1310 then forwards the updated global parameters νₖ^{ij} to the UEs 1320 at 1314. Thereafter, the AP-UE pairs perform another set of local operations 1316 using the updated global parameters ρₖ^{ji} and νₖ^{ij}. The local operations 1316 may be the same as or similar to the local operations 1312.

Extensions for Local Operations

In some cases, additional inputs may be provided as input to the NN, not just the channel measurements from RX side. For example, in some embodiments, channel measurements from the TX side may be provided to the NN in addition to the channel measurements from RX side.

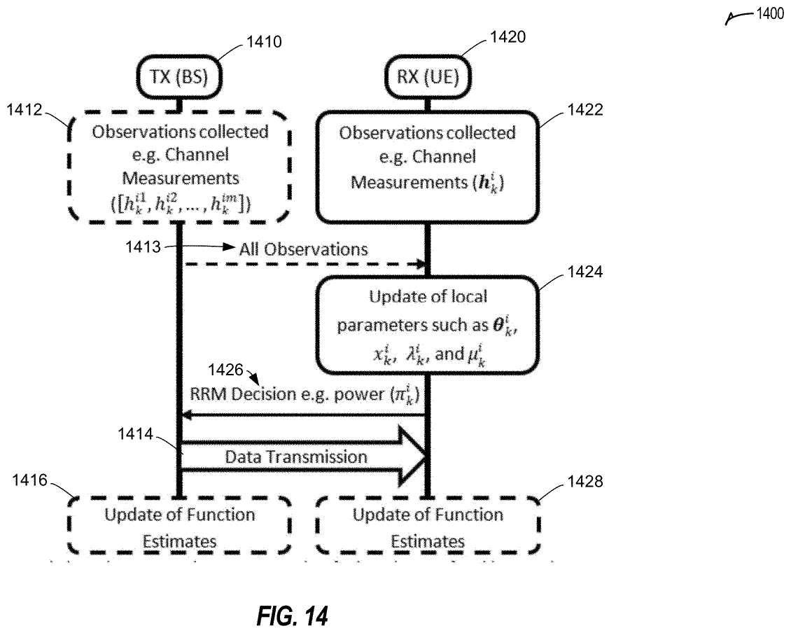

FIG. 14 illustrates extended example local operations 1400 that may take place between a TX and RX in a distributed NN-based RRM optimization technique for downlink communications. In the example shown in FIG. 14, the RX 1420 (which is a UE in this example) measures the current channel at 1422. In addition, the TX 1410 (which is a BS in this example) measures the current channel at 1412 and provides the channel measurements to the RX 1420 at 1413. The RX 1420 updates the local parameters (θₖⁱ, xₖⁱ, λₖⁱ, and μₖⁱ) at 1424 using the channel measurements from both the TX 1410 and RX 1420. The RX 1420 then retrieves the policy decision (πₖⁱ) made on the NN of the RX 1420 and forwards it to the TX 1410 (BS) at 1426. Data can then be transmitted at 1414 at the power level decided by the NN (i.e., based on the policy decision (πₖⁱ)). After the data transmission at 1412, the estimates of functions may be used in the update of global parameters (ρₖ^{ji} and νₖ^{ij}) 1416, 1428 by the TX 1410 and RX 1420, respectively as described above.

In addition, in some cases, the NN can take past observations into account as well. For example, past decisions of other NNs can be used when deciding future power levels if they can be observed by the NN. Further, the NN does not need to output the transmit power only as described above—it may also provide a decision on other wireless communication resources, such as frequency bands to transmit on, etc.

Even though a NN is described above as being the policy/decision maker in the examples above, the policy/decision making may be performed in some instances by a parameterized function whose parameters can be optimized using a gradient decent process (i.e., differentiable).

Simulation Results

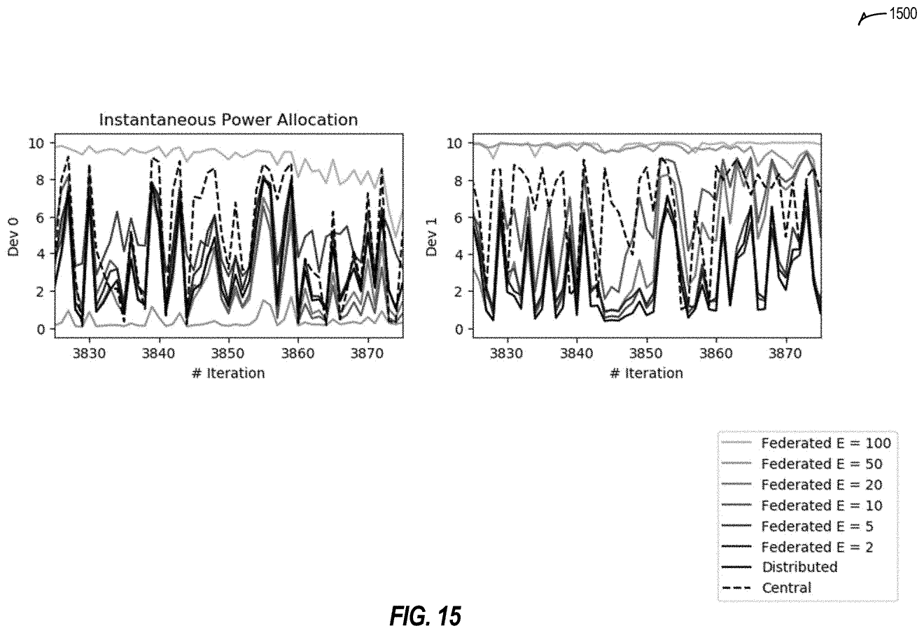

A simulation comparing the distributed model described above with a centralized model shows positive results. For the simulation setup, an interference channel was chosen with 2 TXs and 2 RXs, where channels are IID with Rayleigh (σ=1), the noise level is 0 dBm and the max TX power is 10 dBm. Since the interference can be higher than the noise, expected result will be time sharing between 2 links. We used 32+16 hidden units at each policy makers. We ignored the backhaul delay to focus on the performance of the algorithm specifically. Step sizes were chosen as γ_{θ,k}=γ_{x,k}=γ_{λ,k}=γ_{μ,k}=and 0.01 and γ_{P,k}=γ_{N,k}=0.01 E, where E is the number of updates of local parameters taken before a global update. The term “Federated” is used below and in FIGS. 15-17 whenever E is greater than one to emphasize that the learning (θ update) continues as new data arrives even if those updates are not finalized by a central sync-up.

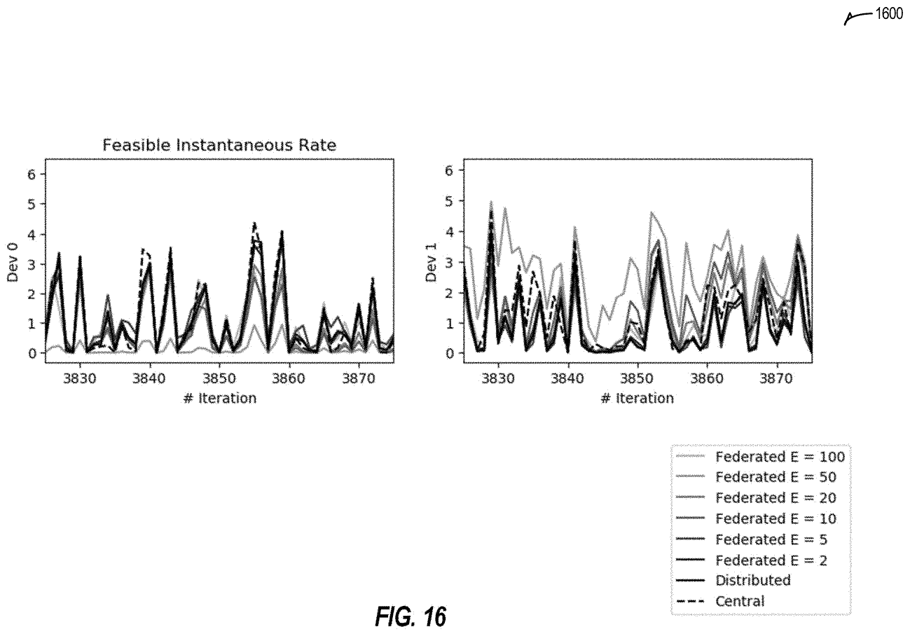

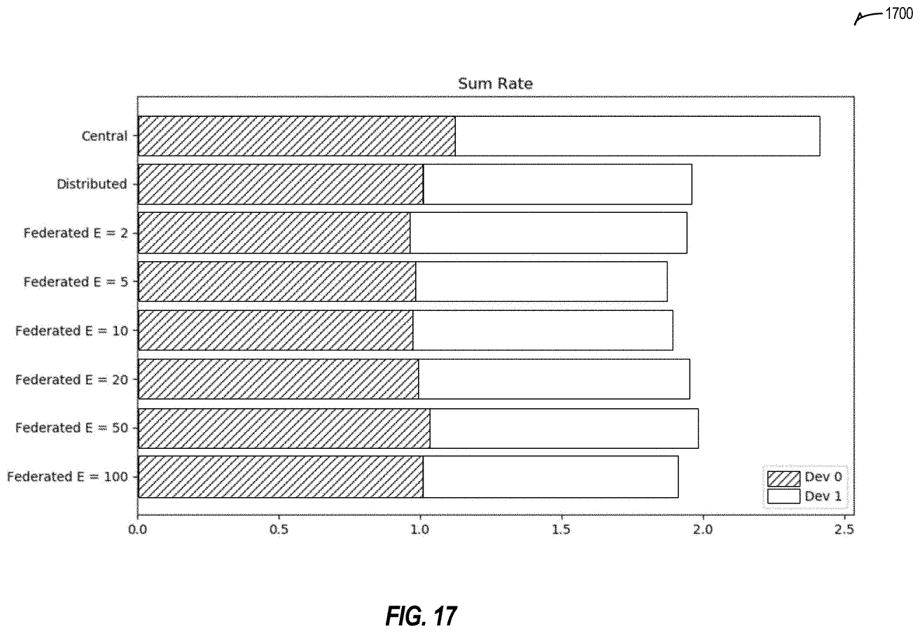

As shown in FIGS. 15-16, the instantaneous decisions and the resulting capacity follow similar trends for central algorithm and distributed algorithm for E ∈ {1,2,5,10,20}. However, when E is 50 or 100, it follows a different time-share policy where the periodicity is much higher. If we look at the average rate through 4000 simulation time (number of channel measurements) in FIG. 17, selection of E does not affect the performance due to the learning rate adjustment of global variables. The sum rate difference between central and distributed solutions are due to slower convergence rate to the policy. During the slow start in distributed algorithm convergence, policies for both devices take conservative steps towards the optimal policy.

Example Implementations

In some example implementations, a policy maker for RRM decisions (e.g., a BS or computationally more capable side of the downlink) utilizes parameters trained via gradient descent process to make the RRM decisions. The policy maker may be a neural network or a parameterized function whose parameters can be optimized using a gradient decent process, in some cases. Inputs to the policy maker or inputs to policy maker gradient update function can include, but are not limited to, local channel observations, past local decisions, locally observable past decisions of other policy makers, local constraints, and global feedback they receive from other policy makers. Each policy maker can independently choose as many interferer as it can track and apply a neural network (NN) (e.g., a convolutional neural network (CNN)) or any other machine learning (ML) algorithm to utilize permuted interfering channel data. The policy maker may have local parameter updates via gradient descent after channel measurements or measurement feedback and before making the RRM decision for that channel conditions. The policy maker or BS may update predefined RRM function values based on the current and previous decisions and performances.

In some example implementations, a global update period for the whole network includes the following operations. Local parameters may be before (or keeping them unchanged during) a global parameter update period (e.g., the global update period shown in FIG. 13, including the operations 1302, 1304, 1306). Global parameter information may be calculated at the BS, or may be calculated and sent by the UE to the BS before BS-to-GW communication. The global parameter information may be shared with the GW by the BS, and may be updated by the GW with respect to global parameter information, the number of local updates since the last global update, and/or the time passed since the last update. The updated global parameters may be shared with relevant APs thereafter, and may be shared to UE (if it is the policy maker for the RRM decisions).

Power Management in Cellular Uplink Channel

Legacy power control solutions in cellular uplink channel are based on desired SNR at the base station (BS), which is the receiver (RX) of the uplink data communication. They usually do not consider the interference they will hear from other user equipment (UE) or the interference they will cause to neighboring BSs. An extension of the techniques described above for downlink communications may be applied to uplink communications.

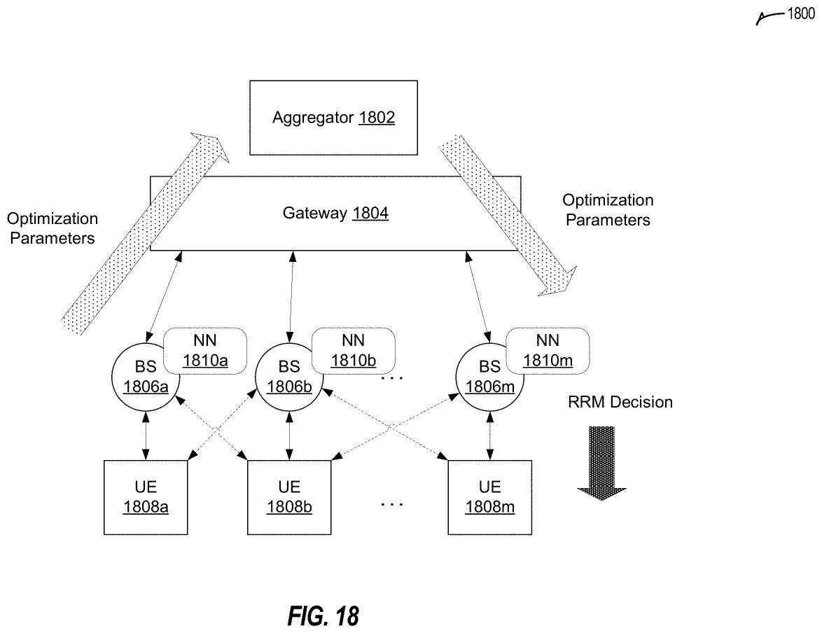

FIG. 18 illustrates an example system 1800 implementing a distributed NN-based RRM optimization technique for uplink communications. In the example shown, the system architecture is similar to that of FIG. 10, except that each BS (RX) 1806 implements its own NN 1810. The BS 1806 generate optimization parameters that are distributed to the other BS 1806, and to gateway 1804 and aggregator 1802 through the backhaul. The NNs 1810 may in turn utilize the shared optimization parameters to arrive at RRM decisions. The optimization parameters may be shared, in some cases, as often as once in a channel coherence period. These optimization parameters may utilize less bandwidth than the sharing of channel measurements described above with respect to the centralized techniques, and accordingly may provide one or more advantages over centralized RRM optimization techniques. RRM decisions will still need to be exchanged often but will not need to be exchanged over the backhaul as in the centralized techniques.

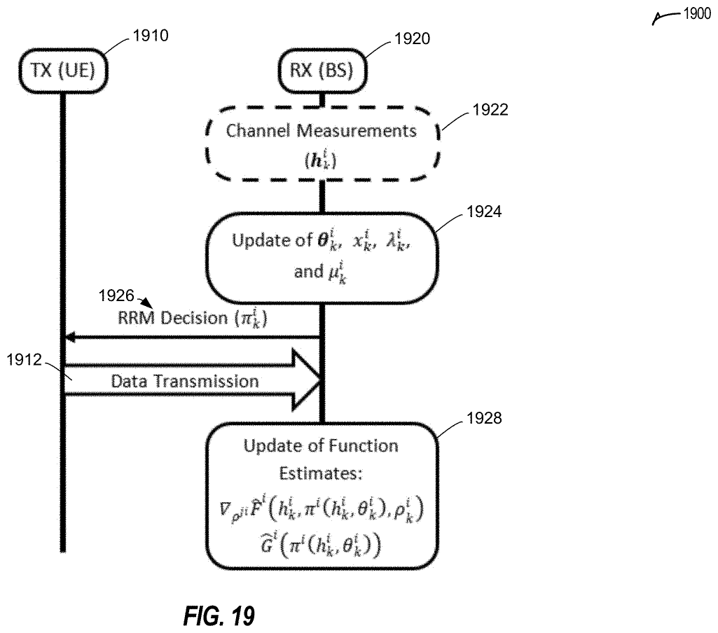

In some embodiments, a control signaling framework 1900 as shown in FIG. 19 may be utilized between TX (UE) 1910 and RX (BS) 1920 in a pair, and between RXs (BSs). As shown in FIG. 19, once the RX 1920 (BS in uplink embodiment) measures the current channel at 1922, it updates local parameters (θₖⁱ, xₖⁱ, λₖⁱ, and μₖⁱ) locally at 1924 and then retrieves the decision made on the updated NN (the policy decision (πₖⁱ)) and forwards it to the TX (UE) 1910 at 1926. Thereafter, data can be transmitted at 1912 at the power level decided by the NN (e.g., based on the policy decision (πₖⁱ)).

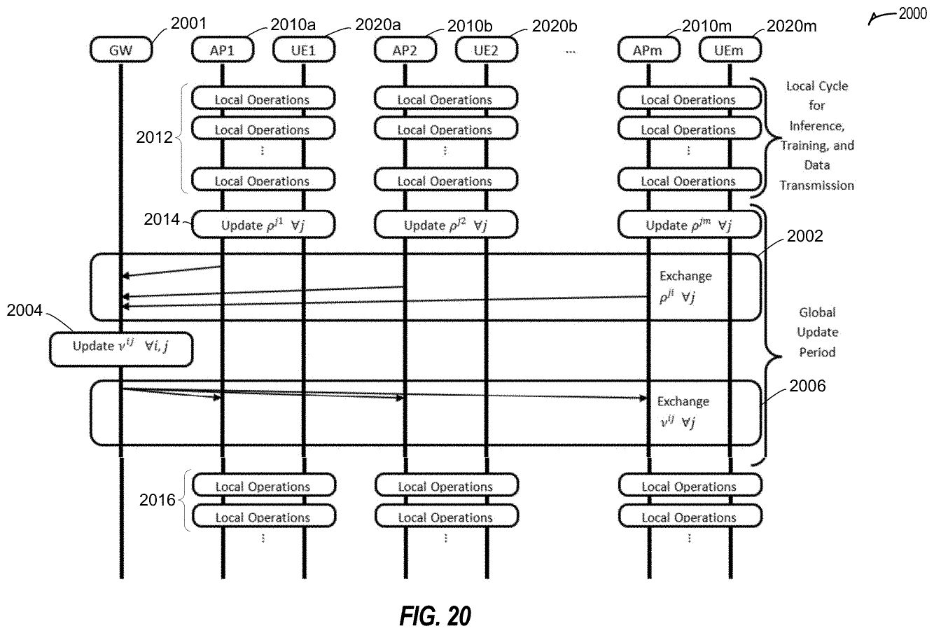

After the data transmission at 1912, the estimates of functions may be used in the update of global parameters (ρₖ^{ji} and νₖ^{ij}) at 1928 by the RX (BS) 1920. Even though these global parameters are not necessarily updated at every iteration, functions required for their update include estimates of expectations over channel instances, which can be updated at every new channel observation locally. Assuming BS will be more capable in terms of computation and it is closer to the rest of the work, these estimations can be calculated at BS. As before, these local signaling and local calculations shown in FIG. 19 may be referred to as “local operations”. The local operations shown in FIG. 19 may be repeated a number of times until the next global update, which is described below with reference to FIG. 20.

As in the downlink case above, some information may be exchanged between BSs during the global parameter update. FIG. 20 illustrates example global parameter update operations 2000 that may take place in a distributed NN-based RRM optimization technique for uplink communications. In the uplink power control problem, global parameters ρₖ^{ji} and νₖ^{ij} are kept in BSi, ∀j. However, the update of ρₖ₊₁^{ji} requires νₖ^{ji}, which may not be present at BSi, and the update of νₖ₊₁^{ij} requires ρₖ₊₁^{ij}, which may not be present at BSi. Therefore, these parameters may be exchanged immediately after their update. Because of the primal-dual update technique, the global update period may include one update and exchange of primal parameters and one update and exchange of dual parameters. After these exchanges, local operations can continue as described. However, during global exchanges, the step for update of local parameters can be skipped in the local operations. FIG. 20 shows the global update period, where these calculations and exchange happen. Some advantages of having such framework may include that it allows faster inference because NN parameters (θⁱ) and inputs (hⁱ) are local and that training on NN parameters can continue as new data arrives, similar to downlink.

In the example shown in FIG. 20, each access point (AP) 2010 (e.g., BS) and UE 2020 pair first performs the local operations 2012 to update local primal and dual parameters for a NN-based model. In some embodiments, the local operations 2012 may include the operations described above with respect to FIG. 19. The local operations 2012 may be performed a number of times as shown.

After some amount of time or some number of iterations of the local operations 2012, the global parameters ρₖ^{ji} are updated between the AP-UE pair at 2014, and then the global parameters ρₖ^{ji} are exchanged with a central gateway 2001 at 2002 by the APs 2010. The gateway 2001 uses the global parameters ρₖ^{ji} to update the global parameters νₖ^{ij} at 2004, and then exchanges the global parameters νₖ^{ij} with the APs 2010 at 2006. Thereafter, the AP-UE pairs perform another set of local operations 2016 using the updated global parameters ρₖ^{ji} and νₖ^{ij}. The local operations 2016 may be the same as or similar to the local operations 2012.

Extensions for Local Operations

Additional inputs may be provided as input to the NN, not just the channel measurements from RX side. For example, in some embodiments, channel measurements from the TX side may be provided to the NN in addition to the channel measurements from RX side.

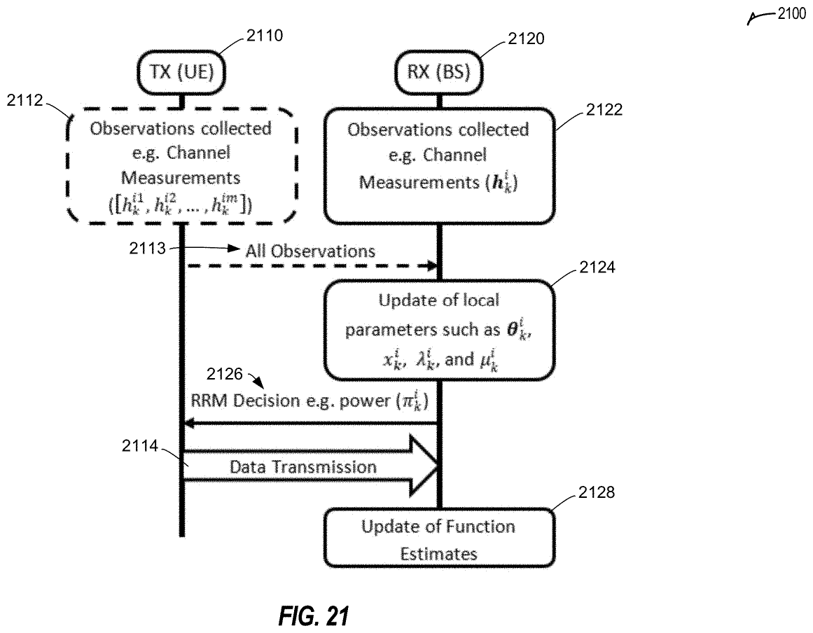

FIG. 21 illustrates extended example local operations 2100 that may take place between a TX and RX in a distributed NN-based RRM optimization technique for uplink communications. In the example shown in FIG. 21, the RX 2120 measures the current channel at 2122. Likewise, the TX 2110 measures the current channel at 2112, and provides the channel measurements to the RX 2120 at 2113. The RX 2120 updates local parameters (θₖⁱ, xₖⁱ, λₖⁱ, and μₖⁱ) locally at 2124 using the channel measurements from both the TX 2110 and RX 2120. The RX 2120 then retrieves the decision made on the updated NN (the policy decision (πₖⁱ)) and forwards it to the TX 2110 (UE) at 2126. Data can then be transmitted at 2114 at the power level decided by the NN (i.e., based on the policy decision (πₖⁱ)). After the data transmission at 2112, the estimates of functions may be used in the update of global parameters (ρₖ^{ji} and νₖ^{ij}) at 2128 by the RX 2120 as described above.

In addition, in some cases, the NN can take past observations into account as well. For example, past decisions of other NNs can be used when deciding future power levels if they can be observed by the NN. Further, the NN does not need to output the transmit power only as described above. It may also provide a decision on other wireless communication resources, such as frequency bands to transmit on, etc.

Even though a NN is described above as being the policy/decision maker in the examples above, the policy/decision making may be performed in some instances by a parameterized function whose parameters can be optimized using a gradient decent process (i.e., differentiable).

Example Implementations

In some example implementations, a policy maker for RRM decisions (e.g., a BS or computationally more capable side of the downlink) utilizes parameters trained via gradient descent process to make the RRM decisions. The policy maker may be a neural network or a parameterized function whose parameters can be optimized using a gradient decent process, in some cases. Inputs to the policy maker or inputs to policy maker gradient update function can include but are not limited to local channel observations, past local decisions, locally observable past decisions of other policy makers, local constraints, and global feedback they receive from other policy makers. Each policy maker can independently choose as many interferer as it can track and apply CNN or any other ML algorithm to utilize permuted interfering channel data. The policy maker may have local parameter updates via gradient descent after channel measurements or measurement feedback and before making the RRM decision for that channel conditions. The policy maker (e.g., BS) may update predefined RRM function values based on the current and previous decisions and performances.

In some example implementations, a global update period for the whole network includes the following operations. Local parameters may be updated before (or keeping them unchanged during) a global parameter update period (e.g., the global update period shown in FIG. 20, including the operations 2002, 2004, 2006). Global parameter information may be calculated at BS, and may be shared with the GW. Global parameters may be updated by the GW with respect to global parameter information, the number of local updates since the last global update, and/or the time passed since the last update. The updated global parameters may be shared with other BSs.

Power Control in Ad-Hoc Wireless Environments

The distributed framework described above may be extended for use cases that include Ad-hoc wireless network connections as well. For instance, instead of having an RRM decision structure for whole network in a central node, some embodiments may utilize an individual RRM decision substructure for each link on the device side (either as transmitter or receiver) so that both inference and training of local parameters can continue at the edge device, based on new channel measurements, in an on-line manner. Although similar to the above approaches, the decentralized technique can extended to ad-hoc networks by having parameter-specific aggregators instead of a single aggregator (e.g., aggregators 1002, 1802). Each aggregator may be responsible for the update of a different set of parameters.

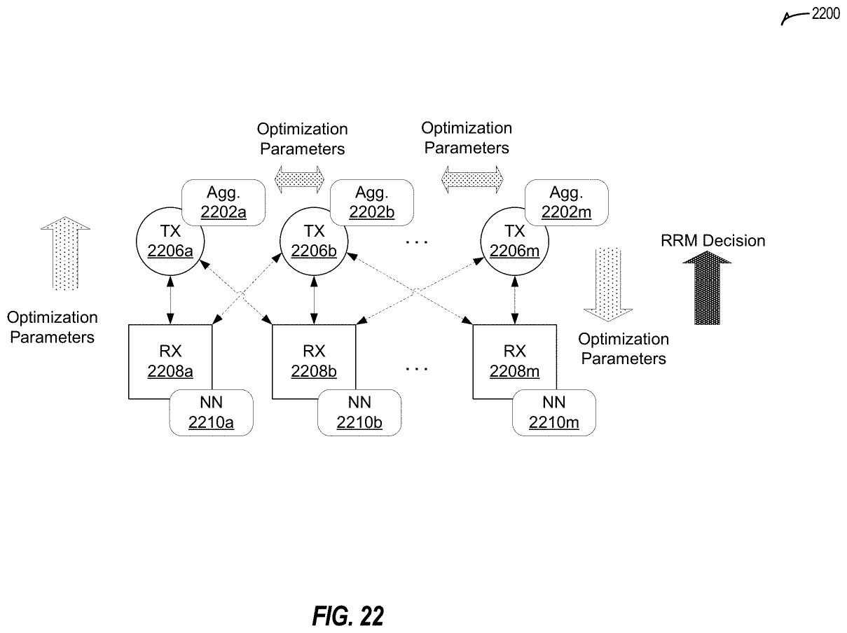

FIG. 22 illustrates an example system 2200 implementing a distributed NN-based RRM optimization technique in an ad-hoc network. In the example shown, aggregators 2210 are all located on TX nodes 2206 of the ad-hoc network system 2200 (the example shown refers to the downlink implementation). Each aggregator 2210 may be responsible for a single set of primal-dual variable updates. Since the parameter dependency is determined by the wireless interference graph, it may be sufficient to have direct communication links between interfering TX nodes 2206. This structure may help with the scalability of the proposed architecture. Otherwise, the system 2200 may function similar to the system 1000 of FIG. 10. That is, the RX nodes 2208 generate optimization parameters that are distributed to the TX nodes 2206 and aggregators 2210. The NNs 2210 may in turn utilize the shared optimization parameters to arrive at RRM decisions. The optimization parameters may be shared, in some cases, as often as once in a channel coherence period. Although NNs 2210 are illustrated as being at RXs 2208 in FIG. 22, one or more of the NNs 2210 may be at TXs 2206 instead. For instance, some NN 2210a may be at RX 2208a as shown, while NN 2210b may be at TX 2206b. Likewise, in some embodiments, all NNs 2210 may be at the TXs 2206.

As with the other embodiments, this embodiment may allow devices with heterogeneous computation capabilities to develop an RRM solution in a federated manner, allowing for reduced feedback as well online solution approaches, which can adapt better to local conditions, unlike the framework for central solution. Furthermore, such embodiments can help scaling the ad-hoc wireless networks while taking interference into account.

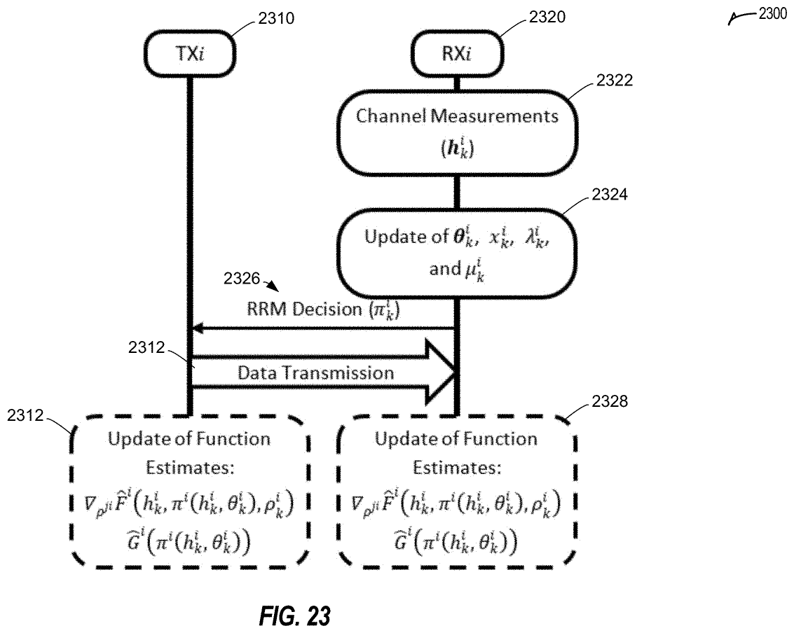

In some embodiments, a control signaling framework as shown in FIG. 23 may be utilized between the TX 2310 and RX 2320. In the example shown, the Transmitter Device (TX) may refer to the transmitting side of the wireless data transmission. It may have both transmission and reception capabilities when exchanging control signals, pilot signal, or channel state information. Further, the Receiver Device (RX) may refer to the receiving side of the wireless data transmission. It may have both transmission and reception capabilities when exchanging control signals, pilot signal, or channel state information.

As shown in FIG. 23, once the RX 2320 measures the current channel at 2322, it updates local parameters (θₖⁱ, xₖⁱ, λₖⁱ, and μₖⁱ) locally at 2324, retrieves the decision made on the updated NN and forwards it to the TX 2310 at 2326. Data can then be transmitted at 2312 at the power level decided by the NN. After the data transmission 2312, the estimates of functions may be used in the update of global parameters (ρₖ^{ji} and νₖ^{ij}) at 2314, 2328 by the TX 2310 and RX 2320, respectively. Though these global parameters are not necessarily updated at every iteration, functions required for their update include estimates of expectations over channel instances, which can be updated at every new channel observation locally. Depending on the availability of the required information and the computation capabilities, these estimations can be calculated at either the TX side or RX side. As above, the local signaling and local calculations shown in FIG. 23 may be referred to as “local operations”. The local operations may be repeated over and over until the next global update is performed, as described below.

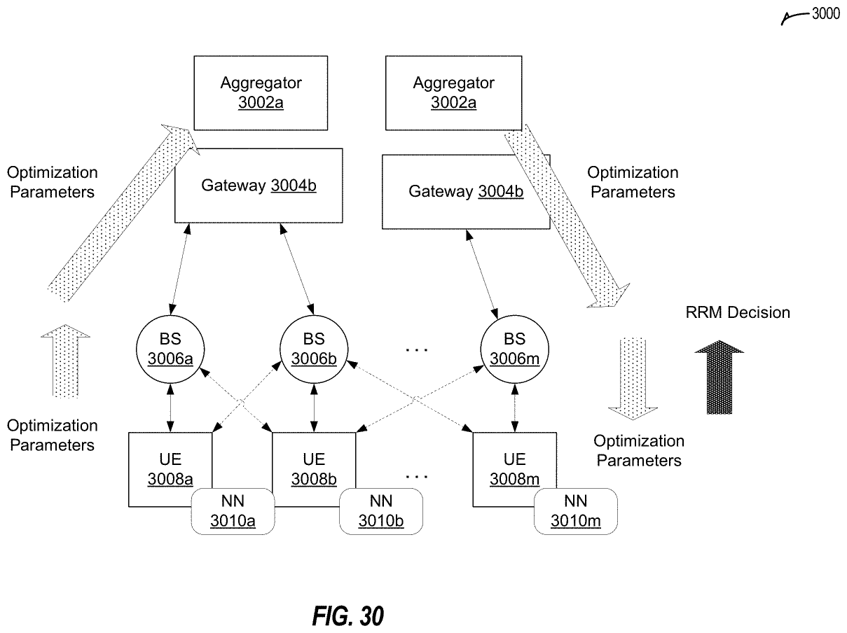

As with the techniques described above, some information may be exchanged between access points (AP) during the global parameter update. In a generalized network context (including ad-hoc, cellular, Wi-Fi networks, etc.), an Access Point (AP) may refer to a node (either TX or RX) in data transfer that has shorter path to access points of other data transmission nodes. For example, Wi-Fi access points are 1 hop closer to other Wi-Fi access points than their clients to other Wi-Fi access points. Base stations in cellular network are another example. Vehicles in a mesh network can be seen as access points in this concept as well, where backhaul communication is handled through V2V communication or through installed stationary equipment on the roads. Further, in the generalized context, User Equipment (UE) may refer to a node (either TX or RX) in the data transfer that is not an AP, such as Wi-Fi users or cellular UEs. IoT (or handheld) devices in a vehicle that are wirelessly connected to the vehicle's modem are another example of a UE in this context. A Central Node (CN) in the generalized context may refer to a node in the network that has link to more than one AP. The links from each AP to the central node may have lower latency than the links between APs. There can be more than one central node in some instances (e.g., as shown in FIG. 30).

A Policy maker may refer to a parameterized function that determines the local RRM policy (one for each TX-RX pair) given all the current and past observations about the channel state and past policy decisions. The policy maker may be differentiable with respect to its parameters, and the outcome of the policy does not need to be deterministic. They can be parameters of a certain probability distribution from which the RRM decision will be sampled. The policy maker can be either at TX or at RX depending on computation capabilities of nodes. The node (TX or RX) with more computation resources can be the policy maker in some instances. It can also be either at UE or at AP (although having it at AP may be preferred in some instances, e.g., to reduce the number of communication steps required during global update period). Global Parameter Information may refer to any piece of information about the global parameter. That is, it can include the gradient value, the step size, components for gradient, or the global parameter itself.

In the power control problem, global parameters ρₖ^{ji} and νₖ^{ij} are kept in APi or UEi, ∀j. However, the update of ρₖ₊₁^{ji} requires νₖ^{ji}, which may not be present at APi, and the update of νₖ₊₁^{ij} requires ρₖ₊₁^{ij}, which may not be present at APi. Therefore, these parameters need to be exchanged immediately after their update. Because of the primal-dual update method in the present disclosure, the global update period may include one update and exchange for primal parameters and one update and exchange for dual parameters. After these exchanges, local operations can continue as described below. In some cases, during global exchanges, the step for update of local parameters can be skipped in the local operations.

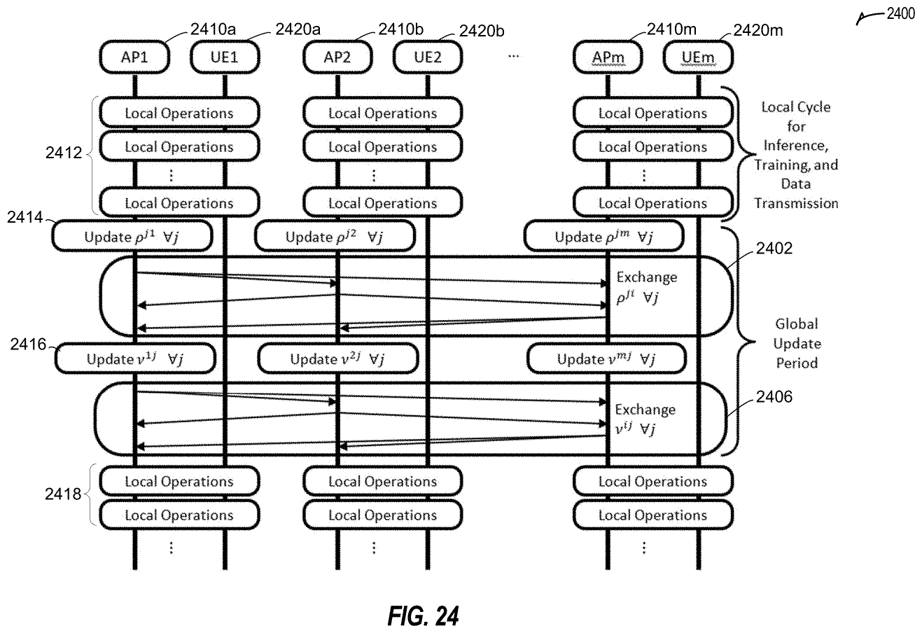

FIG. 24 illustrates example global parameter update operations 2400 that may take place in a distributed NN-based RRM optimization technique for ad-hoc networks. In particular, FIG. 24 illustrates an example global update period, where these calculations and exchange happen. In contrast to the techniques described above with respect to FIGS. 8-21, there may be multiple central nodes (CNs) or multiple APs that can operate as central nodes. One advantage of having such a framework are that it may allow faster inference because NN parameters (θⁱ) and inputs (hⁱ) are local and that training on NN parameters can continue as new data arrives.

In the example shown in FIG. 24, each AP 2410 and UE 2420 pair first performs the local operations 2412 to update local primal and dual parameters for a NN-based model. In some embodiments, the local operations 2412 may include the operations described above with respect to FIG. 23. The local operations 2412 may be performed a number of times as shown.

After some amount of time or some number of iterations of the local operations 2412, the global parameters ρₖ^{ji} are updated between the AP-UE pair at 2414, and then the global parameters ρₖ^{ji} are exchanged amongst the APs at 2402. The APs then use the global parameters ρₖ^{ji} to update the global parameters νₖ^{ij} at 2416, and then exchange the global parameters νₖ^{ij} with the other APs 2410 at 2406. In some cases, the APs 2410 may each be assigned a respective subset of the global parameters to update. Thereafter, the AP-UE pairs perform another set of local operations 2418 using the updated global parameters ρₖ^{ji} and νₖ^{ij}. The local operations 2418 may be the same as or similar to the local operations 2412.

Pre-Update Operations

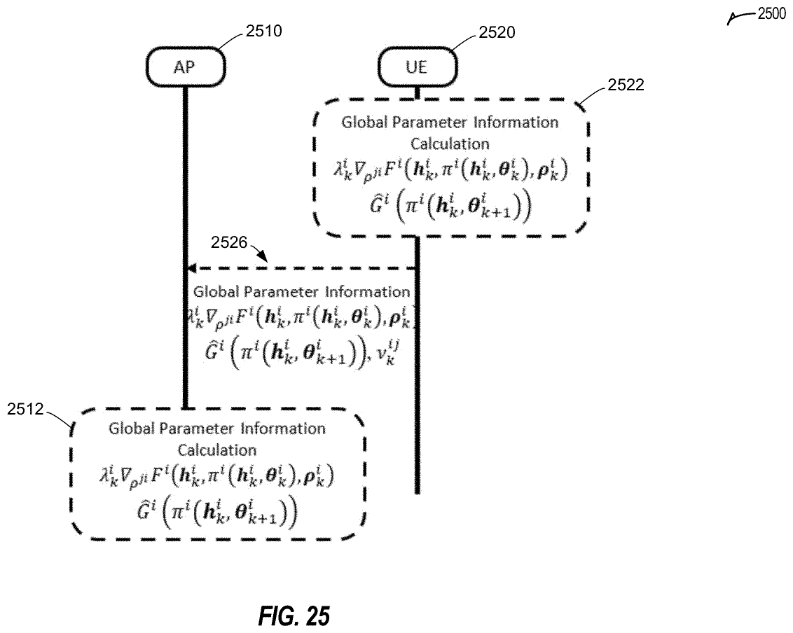

FIG. 25 illustrates a set of pre-update operations 2500 that may be performed for a distributed NN-based RRM optimization technique. The pre-update operations may be an initial part of a global update period where information about global parameters are obtained at an AP. If the policy maker is at the AP or if enough RRM function updates in local operations are done in AP, then the information can be calculated directly at AP. Otherwise, it may be calculated (at least partially) at UE and sent to AP. For example, referring to FIG. 25, the UE 2520 performs part of a global parameter information calculation and transmits the information to the AP 2510 at 2526, whereby the AP 2510 performs the remaining global parameter information calculations.

Global Parameter Information Exchange

Once calculated, the global parameter information may be exchanged amongst the APs of a network to update global parameters they are responsible for. Along with this information, each AP may send the number of local parameter updates that have happened and the time has passed since the last global update. In certain instances, the AP may also send other hyper parameters that were used since the last update or that will be used in the next updates. These transmissions can be multicast, unicast, or broadcast depending of the nature of the information. It can also be through intermediate nodes (such as a central node in a system). Each AP may choose the subset of APs (e.g. dominant interferers to their data transmission) when imposing the constraints for the problem and then communicate between them only. Once all the components are received, the APs can perform the global parameter update. If the update for global parameters of an AP is handled by a CN (e.g., as described above), then other APs exchange global parameter information with this central node.

There may be two sets of information exchanged to allow consecutive primal-dual update in the algorithm. In the first exchange, λₖⁱ∇_{ρ}_{^{ji}}Fⁱ (hₖⁱ, πⁱ(hₖⁱ, θₖⁱ), ρₖⁱ) and νₖ^{ji} are shared with aggregator nodes (either central node or other APs). In the second one, ρₖ₊₁^{ij} are shared with APs. In some cases, the APs may make the global parameter update. If some cases, they may outsource this duty to their UEs or to a CN.

Post-Update Operations

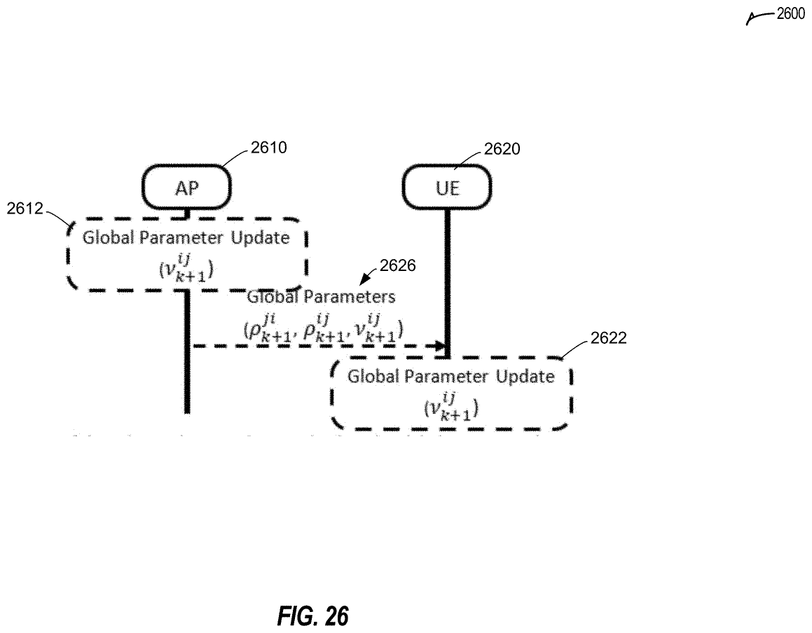

FIG. 26 illustrates a set of post-update operations 2600 that may be performed for a distributed NN-based RRM optimization technique. Once the APs receive information on global parameters that are updated by the network and that are needed by their policy, they can update the dual parameters and forward these parameters to their UEs if the policy maker is at the UE side or update the dual parameters at UE. For example, as shown in FIG. 26, the AP 2610 performs a portion of the global parameter update at 2612 and sends the updated global parameters to the UE 2620 at 2626. The UE 2626 then performs the remaining portions of the global parameter update at 2622.

Extensions for Local Operations

Additional inputs may be provided as input to the NN, not just the channel measurements from RX side. For example, in some embodiments, channel measurements from the TX side may be provided to the NN in addition to the channel measurements from RX side.

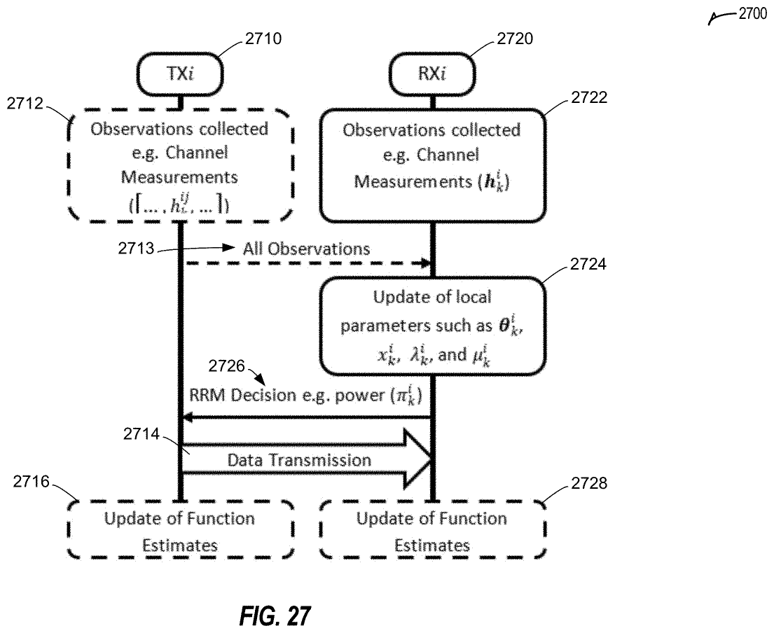

FIG. 27 illustrates extended example local operations 2700 that may take place between a TX and RX in a distributed NN-based RRM optimization technique for ad-hoc networks. In the example shown in FIG. 27, the RX 2720 measures the current channel at 2722. Likewise, the TX 2710 measures the current channel at 2712, and provides the channel measurements to the RX 2720 at 2713. The RX 2720 updates local parameters (θₖⁱ, xₖⁱ, λₖⁱ, and μₖⁱ) locally at 2724 using the channel measurements from both the TX 2710 and RX 2720. The RX 2720 then retrieves the decision made on the updated NN and forwards it to the TX 2710 (UE) at 2726. Data can then be transmitted at 2714 at the power level decided by the NN. After the data transmission at 2712, the estimates of functions may be used in the update of global parameters (ρₖ^{ji} and νₖ^{ij}) at 2728 by the RX 2720 and at 2716 by the TX 2710.

In addition, in some cases, the NN can take past observations into account as well. For example, past decisions of other NNs can be used when deciding future power levels if they can be observed by the NN. Further, the NN does not need to output the transmit power only as described above. It may also provide a decision on other wireless communication resources, such as frequency bands to transmit on, etc.

Even though a NN is described above as being the policy/decision maker in the examples above, the policy/decision making may be performed in some instances by a parameterized function whose parameters can be optimized using a gradient decent process (i.e., differentiable).

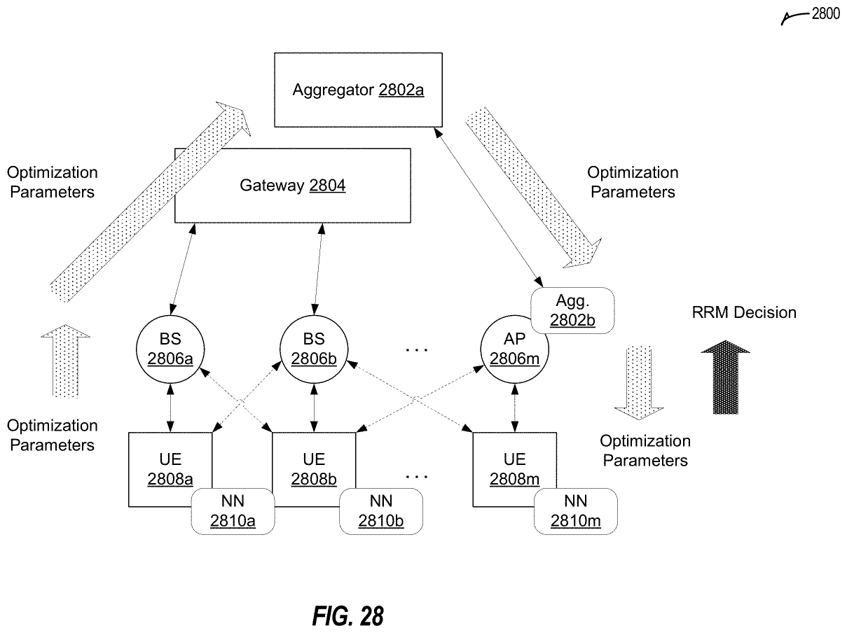

FIG. 28 illustrates another an example system 2800 implementing a distributed NN-based RRM optimization technique. In the example shown, the system architecture is similar to that of FIG. 10, except that the aggregator responsibilities are shared between the aggregator 2802a at gateway 2804 and the aggregator 2802b at base station/AP 2806m. Each UE 2808 implements its own NN 2810. The UEs 2808 generate optimization parameters that are distributed to the BS 2806. The NNs 2810 may utilize the shared optimization parameters to arrive at RRM decisions.

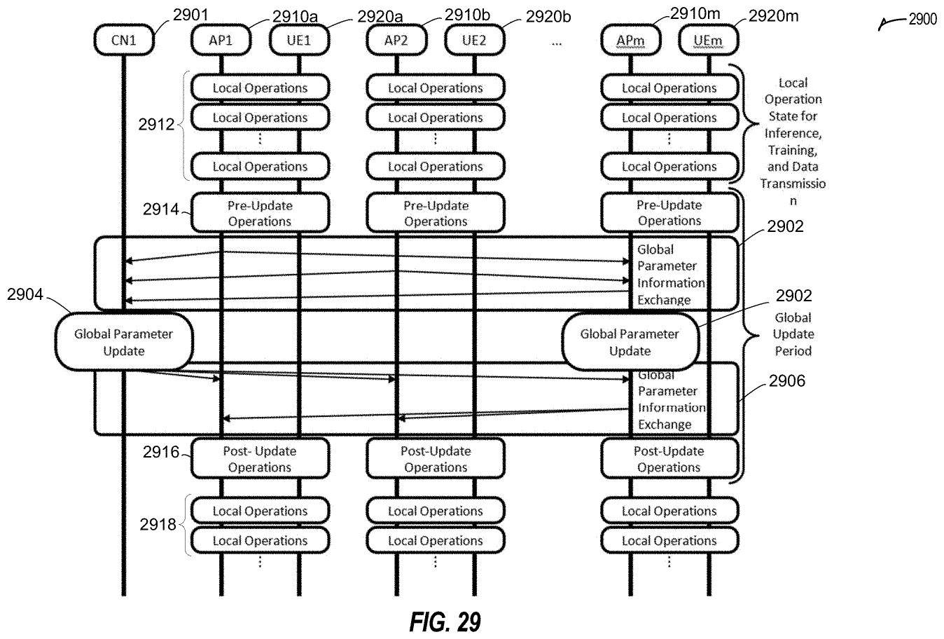

FIG. 29 illustrates example global parameter update operations 2900 for the system 2800 of FIG. 29. In the example shown in FIG. 29, each AP 2910 and UE 2920 pair first performs the local operations 2912 as described above. After some amount of time, pre-update operations are performed the AP-UE pair at 2914. For example, global parameters ρₖ^{ji} may be updated, e.g., as described above with respect to FIG. 25. Next, and then the global parameters ρₖ^{ji} are exchanged with the central node 2901 (e.g., a gateway) at 2902 by the APs 2910. The CN 2901 uses the global parameters ρₖ^{ji} to update the global parameters νₖ^{ij} at 2904, and then exchanges the global parameters νₖ^{ij} with the APs 2910 at 2906. The APs 2910 then perform post-update operations at 2916. For example, the global parameters νₖ^{ij} may be updated as described above with respect to FIG. 26. The updated global parameters may also be forwarded to the UEs 2920 during the post-update operations (e.g., where the policy makers reside at the UEs). Thereafter, the AP-UE pairs perform another set of local operations 2918 using the updated global parameters ρₖ^{ji} and νₖ^{ij}.

FIG. 30 illustrates another an example system 3000 implementing a distributed NN-based RRM optimization technique. The example shown is similar to that of FIG. 10, except instead of single aggregator that handles the update of all parameters, there are multiple aggregators 3002 that are responsible for updating different sets of parameters. In some implementations, the aggregators 3002 are responsible for intersecting cluster (sub-set) of primal-dual variable updates, and are all located on the central node gateways 3004. Since the parameter dependency may be determined by the interference graph, it may be sufficient to have a direct communication link between edge-users and neighboring cells. This structure may help improve the scalability of the illustrated architecture.

Example Implementations

In some example implementations, a policy maker for RRM decisions (e.g., a BS or computationally more capable side of the downlink) utilizes parameters that are trained via a gradient descent process to make the RRM decisions. The policy maker may be a neural network or a parameterized function whose parameters can be optimized using a gradient decent process, in some cases. Inputs to the policy maker or inputs to policy maker gradient update function can include but are not limited to local channel observations, past local decisions, locally observable past decisions of other policy makers, local constraints, and global feedback they receive from other policy makers. Each policy maker can independently choose as many interferer as it can track and apply CNN or any other ML algorithm to utilize permuted interfering channel data. The policy maker may have local parameter updates via gradient descent after channel measurements or measurement feedback and before making the RRM decision for that channel conditions. Either the policy maker or AP (or both) may update predefined RRM function values based on the current and previous decisions and performances.

In some example implementations, a global update period for the whole network includes the following operations. Local parameters may be before (or keeping them unchanged during) a global parameter update period. Global parameter information may be calculated at a BS or may be calculated at, and sent by, a UE to a BS before AP-to-GW communication. Global parameter information may be shared with the GW, and global parameters may be updated by the GW with respect to global parameter information, the number of local updates since the last global update, and/or the time passed since the last update. The updated global parameters may be shared with relevant APs, or with UEs if they contain the policy maker.

In some example implementations, the network can be partitioned into subsets of APs where each subset contains strong mutual interferers, and only those APs (or their CNs) in the subset may be considered in the optimization and information exchange. A dynamic partition algorithm can also be implemented where network behavior is studied to form interference graph as function of time. Graph partitions could be based on APs (and UEs) with strongest interfering links. Some telemetry data could be utilized to determine the long-term interference between APs or location information can drive the partition as well.

### Example Edge Computing Implementations

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

As referred to below, an “apparatus of” a server or “an apparatus of” a client or an “apparatus” of an edge compute node is meant to refer to a “component” of a server or client or edge computer node, as the component is defined above. The “apparatus” as referred to herein may refer, for example, include a compute circuitry, the compute circuitry including, for example, processing circuitry and a memory coupled thereto.

Example 1 includes an apparatus of an access point (AP) node of a network, the apparatus including an interconnect interface to connect the apparatus to one or more components of the AP node, and a processor to: perform local update operations for a machine learning (ML) model of a radio resource management (RRM) optimization problem, the local update operations comprising: obtaining channel measurements (h^{ij}) for wireless links between the AP node and user equipment (UE) devices; updating first parameters of the ML model based on the channel measurements; determining a RRM decision for an uplink transmission from a particular UE device to the AP node based on the ML model with the updated first set of parameters; and causing the RRM decision to be transmitted to the particular UE device, the RRM decision to be implemented by the particular UE device for the uplink data transmission from the particular UE device to the AP node.

Example 2 includes the subject matter of Example 1, wherein the processor is further to perform global update operations for the ML model, the global update operations comprising: updating second parameters of the ML model; causing the updated second parameters to be transmitted to one or more aggregator nodes of the network; and obtaining updated third parameter of the ML model from one or more aggregator nodes of the network based on the updated global primal parameters.

Example 3 includes the subject matter of Example 2, wherein the processor is further to perform additional rounds of the local operations based on the updated global primal parameters and updated global dual parameters.

Example 4 includes the subject matter of Example 2, wherein the one or more aggregator nodes of the network include a central node of the network or another AP node.

Example 5 includes the subject matter of Example 1 or 2, wherein the RRM optimization problem is a primal-dual optimization problem.

Example 6 includes the subject matter of Example 5, first parameters of the ML model include local primal parameters (θⁱ, xⁱ) and local dual parameters (λⁱ, μⁱ) of the ML model.

Example 7 includes the subject matter of Example 5, wherein the second parameters of the ML model include global primal parameters (ρ^{ji}) of the ML model, and the third parameters of the ML model include global dual parameters (ν^{ji}) of the ML model.

Example 8 includes the subject matter of any one of Examples 5-7, wherein the dual parameters are Lagrange variables corresponding to constraints of the RRM optimization problem.

Example 9 includes the subject matter of any one of Examples 2-8, wherein the second parameters indicate expected power outputs for transmitters in the network, and the third parameters indicate sensitivities of receivers to other transmitters.

Example 10 includes the subject matter of any one of Examples 1-9, wherein the processor is to update the first parameters based on a gradient descent analysis.

Example 11 includes the subject matter of any one of Examples 1-10, wherein the processor is to update the first parameters of the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 12 includes the subject matter of any one of Examples 1-11, wherein the processor is to update the first parameters further based on additional channel measurements obtained by other AP nodes of the network.

Example 13 includes the subject matter of any one of Examples 1-12, wherein the RRM optimization problem is for one of a transmit power for an uplink data transmission and a frequency band to transmit the uplink data transmission on.

Example 14 includes the subject matter of any one of Examples 1-13, wherein the processor is further, in the local update operations, to update estimates of functions used in the RRM optimization problem.

Example 15 includes the subject matter of any one of Examples 1-14, wherein the ML model is a neural network (NN).

Example 16 includes the subject matter of any one of Examples 1-15, wherein the AP node is a base station of a cellular network.

Example 17 includes one or more computer-readable media comprising instructions that, when executed by one or more processors of an access point (AP) node of a network, cause the one or more processors to: perform local update operations for a machine learning (ML) model of a radio resource management (RRM) optimization problem, the local update operations comprising: obtaining channel measurements (h^{ij}) for wireless links between the AP node and user equipment (UE) devices; updating first parameters of the ML model based on the channel measurements; determining a RRM decision for an uplink transmission from a particular UE device to the AP node based on the ML model with the updated first set of parameters; and causing the RRM decision to be transmitted to the particular UE device, the RRM decision to be implemented by the particular UE device for the uplink data transmission from the particular UE device to the AP node.

Example 18 includes the subject matter of Example 17, wherein the instructions are further to cause the one or more processors to perform global update operations for the ML model, the global update operations comprising: updating second parameters of the ML model; causing the updated second parameters to be transmitted to one or more aggregator nodes of the network; and obtaining updated third parameter of the ML model from one or more aggregator nodes of the network based on the updated global primal parameters.

Example 19 includes the subject matter of Example 18, wherein the instructions are further to cause the one or more processors to perform additional rounds of the local operations based on the updated global primal parameters and updated global dual parameters.

Example 20 includes the subject matter of Example 18, wherein the one or more aggregator nodes of the network include a central node of the network or another AP node.

Example 21 includes the subject matter of Example 17 or 18, wherein the RRM optimization problem is a primal-dual optimization problem.

Example 22 includes the subject matter of Example 21, wherein the first parameters of the ML model include local primal parameters (θⁱ, xⁱ) and local dual parameters (λⁱ, μⁱ) of the ML model.

Example 23 includes the subject matter of of Example 21, wherein the second parameters of the ML model include global primal parameters (ρ^{ji}) of the ML model, and the third parameters of the ML model include global dual parameters (ν^{ji}) of the ML model.

Example 24 includes the subject matter of any one of Examples 21-23, wherein the dual parameters are Lagrange variables corresponding to constraints of the RRM optimization problem.

Example 25 includes the subject matter of any one of Examples 18-24, wherein the second parameters indicate expected power outputs for transmitters in the network, and the third parameters indicate sensitivities of receivers to other transmitters.

Example 26 includes the subject matter of any one of Examples 17-25, wherein the processor is to update the first parameters based on a gradient descent analysis.

Example 27 includes the subject matter of any one of Examples 17-26, wherein the processor is to update the first parameters of the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 28 includes the subject matter of any one of Examples 17-27, wherein the processor is to update the first parameters further based on additional channel measurements obtained by other AP nodes of the network.

Example 29 includes the subject matter of any one of Examples 17-28, wherein the RRM optimization problem is for one of a transmit power for an uplink data transmission and a frequency band to transmit the uplink data transmission on.

Example 30 includes the subject matter of any one of Examples 17-29, wherein the processor is further, in the local update operations, to update estimates of functions used in the RRM optimization problem.

Example 31 includes the subject matter of any one of Examples 17-30, wherein the ML model is a neural network (NN).

Example 32 includes the subject matter of any one of Examples 17-31, wherein the AP node is a base station of a cellular network.

Example 33 includes a method comprising: performing local update operations for a machine learning (ML) model of a radio resource management (RRM) optimization problem, the local update operations comprising: obtaining channel measurements (h^{ij}) for wireless links between the AP node and user equipment (UE) devices; updating first parameters of the ML model based on the channel measurements; determining a RRM decision for an uplink transmission from a particular UE device to the AP node based on the ML model with the updated first set of parameters; and causing the RRM decision to be transmitted to the particular UE device, the RRM decision to be implemented by the particular UE device for the uplink data transmission from the particular UE device to the AP node.

Example 34 includes the subject matter of Example 33, further comprising performing global update operations for the ML model, the global update operations comprising: updating second parameters of the ML model; causing the updated second parameters to be transmitted to one or more aggregator nodes of the network; and obtaining updated third parameter of the ML model from one or more aggregator nodes of the network based on the updated global primal parameters.

Example 35 includes the subject matter of Example 34, further comprising performing additional rounds of the local operations based on the updated global primal parameters and updated global dual parameters.

Example 36 includes the subject matter of Example 34, wherein the one or more aggregator nodes of the network include a central node of the network or another AP node.

Example 37 includes the subject matter of Example 33 or 34, wherein the RRM optimization problem is a primal-dual optimization problem.

Example 38 includes the subject matter of Example 37, wherein the first parameters of the ML model include local primal parameters (θⁱ, xⁱ) and local dual parameters (λⁱ, μⁱ) of the ML model.

Example 39 includes the subject matter of Example 37, wherein the second parameters of the ML model include global primal parameters (ρ^{ji}) of the ML model, and the third parameters of the ML model include global dual parameters (ν^{ji}) of the ML model.

Example 40 includes the subject matter of any one of Examples 37-39, wherein the dual parameters are Lagrange variables corresponding to constraints of the RRM optimization problem.

Example 41 includes the subject matter of any one of Examples 34-40, wherein the second parameters indicate expected power outputs for transmitters in the network, and the third parameters indicate sensitivities of receivers to other transmitters.

Example 42 includes the subject matter of any one of Examples 33-41, wherein updating the first parameters based on a gradient descent analysis.

Example 43 includes the subject matter of any one of Examples 33-42, wherein updating the first parameters of the ML model is further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 44 includes the subject matter of any one of Examples 33-43, wherein updating the first parameters is further based on additional channel measurements obtained by other AP nodes of the network.

Example 45 includes the subject matter of any one of Examples 33-44, wherein the RRM optimization problem is for one of a transmit power for an uplink data transmission and a frequency band to transmit the uplink data transmission on.

Example 46 includes the subject matter of any one of Examples 33-45, further comprising, in the local update operations, updating estimates of functions used in the RRM optimization problem.

Example 47 includes the subject matter of any one of Examples 33-46, wherein the ML model is a neural network (NN).

Example 48 includes the subject matter of any one of Examples 33-47, wherein the AP node is a base station of a cellular network.

Example 49 includes an apparatus of a user equipment device (UE) of a network, the apparatus including an interconnect interface to connect the apparatus to one or more components of the UE device, and a processor to: perform local update operations for a machine learning (ML) model of a radio resource management (RRM) optimization problem, the local operations comprising: obtaining channel measurements (h^{ij}) for wireless links between the UE device and access point (AP) nodes of the network; updating first parameters of the ML model based on the channel measurements; determining a RRM decision for a downlink transmission from a particular AP node to the UE device based on the ML model with the updated first parameters; and causing the RRM decision to be transmitted to the particular AP node, the RRM decision to be implemented by the particular AP node for the downlink data transmission from the particular AP node to the UE device.

Example 50 includes the subject matter of Example 49, wherein the processor is further to perform global operations after the number of rounds of local operations, the global operations comprising: updating second parameters of the ML model; causing the updated second parameters to be transmitted to one or more aggregator nodes of the network; and obtaining updated third parameters of the ML model from one or more aggregator nodes of the network based on the updated global primal parameters.

Example 51 includes the subject matter of Example 50, wherein the processor is further to perform additional rounds of the local update operations based on the updated second parameters and updated third parameters.

Example 52 includes the subject matter of Example 50, wherein the one or more aggregator nodes of the network include a central node of the network or an AP node of the network.

Example 53 includes the subject matter of Example 50 or 51, wherein the RRM optimization problem is a primal-dual optimization problem.

Example 54 includes the subject matter of Example 53, first parameters of the ML model include local primal parameters (θⁱ, xⁱ) and local dual parameters (λⁱ, μⁱ) of the ML model.

Example 55 includes the subject matter of Example 53, wherein the second parameters of the ML model include global primal parameters (ρ^{ji}) of the ML model, and the third parameters of the ML model include global dual parameters (ν^{ji}) of the ML model.

Example 56 includes the subject matter of any one of Examples 53-55, wherein the dual parameters are Lagrange variables corresponding to constraints of the RRM optimization problem.

Example 57 includes the subject matter of any one of Examples 50-56, wherein the second parameters indicate expected power outputs for transmitters in the network, and the third parameters indicate sensitivities of receivers to other transmitters.

Example 58 includes the subject matter of any one of Examples 49-57, wherein the processor is to update the first parameters based on a gradient descent analysis.

Example 59 includes the subject matter of any one of Examples 49-58, wherein the processor is to update the first parameters further based on additional channel measurements obtained by other AP nodes of the network.

Example 60 includes the subject matter of any one of Examples 49-59, wherein the processor is to update the first parameters to the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 61 includes the subject matter of any one of Examples 49-60, wherein the RRM optimization problem is for one of a transmit power for a downlink data transmission and a frequency band to transmit the downlink data transmission on.

Example 62 includes the subject matter of any one of Examples 49-61, wherein the processor is further, in the local update operations, to update estimates of functions used in the RRM optimization problem.

Example 63 includes the subject matter of any one of Examples 49-62, wherein the ML model is a neural network (NN).

Example 64 includes one or more computer-readable media comprising instructions that, when executed by the one or more processors, cause the one or more processors to: perform local update operations for a machine learning (ML) model of a radio resource management (RRM) optimization problem, the local operations comprising: obtaining channel measurements (h^{ij}) for wireless links between the UE device and access point (AP) nodes of the network; updating first parameters of the ML model based on the channel measurements; determining a RRM decision for a downlink transmission from a particular AP node to the UE device based on the ML model with the updated first parameters; and causing the RRM decision to be transmitted to the particular AP node, the RRM decision to be implemented by the particular AP node for the downlink data transmission from the particular AP node to the UE device.

Example 65 includes the subject matter of Example 64, wherein the processor is further to perform global operations after the number of rounds of local operations, the global operations comprising: updating second parameters of the ML model; causing the updated second parameters to be transmitted to one or more aggregator nodes of the network; and obtaining updated third parameters of the ML model from one or more aggregator nodes of the network based on the updated global primal parameters.

Example 66 includes the subject matter of Example 65, wherein the processor is further to perform additional rounds of the local update operations based on the updated second parameters and updated third parameters.

Example 67 includes the subject matter of Example 65, wherein the one or more aggregator nodes of the network include a central node of the network or an AP node of the network.

Example 68 includes the subject matter of Example 65 or 66, wherein the RRM optimization problem is a primal-dual optimization problem.

Example 69 includes the subject matter of Example 68, wherein the first parameters of the ML model include local primal parameters (θⁱ, xⁱ) and local dual parameters (λⁱ, μⁱ) of the ML model.

Example 70 includes the subject matter of Example 68, wherein the second parameters of the ML model include global primal parameters (ρ^{ji}) of the ML model, and the third parameters of the ML model include global dual parameters (ν^{ji}) of the ML model.

Example 71 includes the subject matter of any one of Examples 68-70, wherein the dual parameters are Lagrange variables corresponding to constraints of the RRM optimization problem.

Example 72 includes the subject matter of any one of Examples 65-71, wherein the second parameters indicate expected power outputs for transmitters in the network, and the third parameters indicate sensitivities of receivers to other transmitters.

Example 73 includes the subject matter of any one of Examples 64-72, wherein the processor is to update the first parameters based on a gradient descent analysis.

Example 74 includes the subject matter of any one of Examples 64-73, wherein the processor is to update the first parameters further based on additional channel measurements obtained by other AP nodes of the network.

Example 75 includes the subject matter of any one of Examples 64-74, wherein the processor is to update the first parameters to the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 76 includes the subject matter of any one of Examples 64-75, wherein the RRM optimization problem is for one of a transmit power for a downlink data transmission and a frequency band to transmit the downlink data transmission on.

Example 77 includes the subject matter of any one of Examples 64-76, wherein the processor is further, in the local update operations, to update estimates of functions used in the RRM optimization problem.

Example 78 includes the subject matter of any one of Examples 64-77, wherein the ML model is a neural network (NN).

Example 80 includes a method comprising: performing local update operations for a machine learning (ML) model of a radio resource management (RRM) optimization problem, the local operations comprising: obtaining channel measurements (h^{ij}) for wireless links between the UE device and access point (AP) nodes of the network; updating first parameters of the ML model based on the channel measurements; determining a RRM decision for a downlink transmission from a particular AP node to the UE device based on the ML model with the updated first parameters; and causing the RRM decision to be transmitted to the particular AP node, the RRM decision to be implemented by the particular AP node for the downlink data transmission from the particular AP node to the UE device.

Example 81 includes the subject matter of Example 80, further comprising performing global operations after the number of rounds of local operations, the global operations comprising: updating second parameters of the ML model; causing the updated second parameters to be transmitted to one or more aggregator nodes of the network; and obtaining updated third parameters of the ML model from one or more aggregator nodes of the network based on the updated global primal parameters.

Example 82 includes the subject matter of Example 81, further comprising performing additional rounds of the local update operations based on the updated second parameters and updated third parameters.

Example 83 includes the subject matter of Example 81, wherein the one or more aggregator nodes of the network include a central node of the network or an AP node of the network.

Example 84 includes the subject matter of Example 81 or 82, wherein the RRM optimization problem is a primal-dual optimization problem.

Example 85 includes the subject matter of Example 84, wherein the first parameters of the ML model include local primal parameters (θⁱ, xⁱ) and local dual parameters (λⁱ, μⁱ) of the ML model.

Example 86 includes the subject matter of Example 84, wherein the second parameters of the ML model include global primal parameters (ρ^{ji}) of the ML model, and the third parameters of the ML model include global dual parameters (ν^{ji}) of the ML model.

Example 87 includes the subject matter of any one of Examples 84-86, wherein the dual parameters are Lagrange variables corresponding to constraints of the RRM optimization problem.

Example 88 includes the subject matter of any one of Examples 81-87, wherein the second parameters indicate expected power outputs for transmitters in the network, and the third parameters indicate sensitivities of receivers to other transmitters.

Example 89 includes the subject matter of any one of Examples 80-88, wherein updating the first parameters is based on a gradient descent analysis.

Example 90 includes the subject matter of any one of Examples 80-89, wherein updating the first parameters is further based on additional channel measurements obtained by other AP nodes of the network.

Example 91 includes the subject matter of any one of Examples 80-90, wherein updating the first parameters to the ML model is further based on one or more of: previous RRM decisions for the link between the particular UE device and the AP node, previous RRM decisions for other AP-UE links of the network, constraints to one or both of the AP or particular UE device, and information from other RRM decision-makers of the network.

Example 92 includes the subject matter of any one of Examples 80-91, wherein the RRM optimization problem is for one of a transmit power for a downlink data transmission and a frequency band to transmit the downlink data transmission on.

Example 93 includes the subject matter of any one of Examples 80-92, further comprising, in the local update operations, updating estimates of functions used in the RRM optimization problem.

Example 94 includes the subject matter of any one of Examples 80-93, wherein the ML model is a neural network (NN).

Example U1 includes an apparatus of an access point (AP) node of a network, the apparatus including an interconnect interface to connect the apparatus to one or more components of the AP node, and a processor to: perform local operations for a number of rounds, the local operations comprising: obtaining channel measurements (h^{ij}) for wireless links between the AP node and user equipment (UE) devices; updating local primal parameters (θⁱ, xⁱ) and local dual parameters (λⁱ, μⁱ) of a machine learning (ML) model of a radio resource management (RRM) optimization problem based on the channel measurements; determining a RRM decision for an uplink transmission from a particular UE device to the AP node based on the ML model with the updated local primal parameters and updated local dual parameters; and causing the RRM decision to be transmitted to the particular UE device, the RRM decision to be implemented by the particular UE device for the uplink data transmission from the particular UE device to the AP node; and perform global operations after the number of rounds of local operations, the global operations comprising: updating global primal parameters (ρ^{ji}) of the ML model; causing the updated global primal parameters to be transmitted to one or more aggregator nodes of the network; and obtaining updated global dual parameters (ν^{ji}) of the ML model from one or more aggregator nodes of the network based on the updated global primal parameters; wherein the processor is further to perform additional rounds of the local operations based on the updated global primal parameters and updated global dual parameters.

Example U2 includes the subject matter of Example U1, wherein the RRM optimization problem is for one of a transmit power for an uplink data transmission and a frequency band to transmit the uplink data transmission on.

Example U3 includes the subject matter of Example U1, wherein the local and global dual parameters are Lagrange variables corresponding to constraints of the RRM optimization problem.

Example U4 includes the subject matter of Example U1, wherein the global primal parameters indicate expected power outputs for transmitters in the network, and the global dual parameters indicate sensitivities of receivers to other transmitters.

Example U5 includes the subject matter of Example U1, wherein the processor is to update the local primal and dual parameters to the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example U6 includes the subject matter of Example U1, wherein the processor is to update the local primal and dual parameters further based on additional channel measurements obtained by other AP nodes of the network.

Example U7 includes the subject matter of Example U1, wherein the processor is further, in the local operations, to update estimates of functions used in the optimization problem.

Example U8 includes the subject matter of Example U1, wherein the ML model is a neural network (NN).

Example U9 includes the subject matter of Example U1, wherein the processor is to update the local primal and dual parameters based on a gradient descent analysis.

Example U10 includes the subject matter of Example U1, wherein the AP node is a base station of a cellular network.

Example U11 includes the subject matter of Example U1, wherein the one or more aggregator nodes of the network include a central node of the network or another AP node.

Example U12 includes one or more computer-readable media comprising instructions that, when executed by the one or more processors, cause the one or more processors to: perform local operations for a number of rounds, the local operations comprising: obtaining channel measurements (h^{ij}) for wireless links between the AP node and user equipment (UE) devices; updating local primal parameters (θⁱ, xⁱ) and local dual parameters (λⁱ, μⁱ) of a machine learning (ML) model of a radio resource management (RRM) optimization problem based on the channel measurements; determining a RRM decision for an uplink transmission from a particular UE device to the AP node based on the ML model with the updated local primal parameters and updated local dual parameters; and causing the RRM decision to be transmitted to the particular UE device, the RRM decision to be implemented by the particular UE device for the uplink data transmission from the particular UE device to the AP node; and perform global operations after the number of rounds of local operations, the global operations comprising: updating global primal parameters (ρ^{ji}) of the ML model; causing the updated global primal parameters to be transmitted to one or more aggregator nodes of the network; and obtaining updated global dual parameters (ν^{ji}) of the ML model from one or more aggregator nodes of the network based on the updated global primal parameters; wherein the processor is further to perform additional rounds of the local operations based on the updated global primal parameters and updated global dual parameters.

Example U13 includes the subject matter of Example U12, wherein the RRM optimization problem is for one of a transmit power for an uplink data transmission and a frequency band to transmit the uplink data transmission on.

Example U14 includes the subject matter of Example U12, wherein the local and global dual parameters are Lagrange variables corresponding to constraints of the RRM optimization problem.

Example U15 includes the subject matter of Example U12, wherein updating the local primal and dual parameters to the ML model is further based on one or more of: previous RRM decisions for the link between the particular UE device and the AP node, previous RRM decisions for other AP-UE links of the network, constraints to one or both of the AP or particular UE device, and information from other RRM decision-makers of the network.

Example U16 includes the subject matter of Example U12, wherein updating the local primal and dual parameters is further based on additional channel measurements obtained by other AP nodes of the network.

Example U17 includes an apparatus of a user equipment device (UE) of a network, the apparatus including an interconnect interface to connect the apparatus to one or more components of the UE device, and a processor to: perform local operations for a number of rounds, the local operations comprising: obtaining channel measurements (h^{ij}) for wireless links between the UE device and access point (AP) nodes of the network; updating local primal parameters (θⁱ, xⁱ) and local dual parameters (λⁱ, μⁱ) of a machine learning (ML) model of a radio resource management (RRM) optimization problem based on the channel measurements; determining a RRM decision for a downlink transmission from a particular AP node to the UE device based on the ML model with the updated local primal parameters and updated local dual parameters; and causing the RRM decision to be transmitted to the particular AP node, the RRM decision to be implemented by the particular AP node for the downlink data transmission from the particular AP node to the UE device; and perform global operations after the number of rounds of local operations, the global operations comprising: updating global primal parameters (ρ^{ji}) of the ML model; causing the updated global primal parameters to be transmitted to one or more aggregator nodes of the network; and obtaining updated global dual parameters (ν^{ji}) of the ML model from one or more aggregator nodes of the network based on the updated global primal parameters; wherein the processor is further to perform additional rounds of the local operations based on the updated global primal parameters and updated global dual parameters.

Example U18 includes the subject matter of Example U17, wherein the RRM optimization problem is for one of a transmit power for a downlink data transmission and a frequency band to transmit the downlink data transmission on.

Example U19 includes the subject matter of Example U17, wherein the local and global dual parameters are Lagrange variables corresponding to constraints of the RRM optimization problem.

Example U20 includes the subject matter of Example U17, wherein the global primal parameters indicate expected power outputs for transmitters in the network, and the global dual parameters indicate sensitivities of receivers to other transmitters.

Example U21 includes the subject matter of Example U17, wherein the processor is to update the local primal and dual parameters to the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

Example U22 includes the subject matter of Example U17, wherein the processor is to update the local primal and dual parameters further based on additional channel measurements obtained by other AP nodes of the network.

Example U23 includes one or more computer-readable media comprising instructions that, when executed by the one or more processors, cause the one or more processors to: perform local operations for a number of rounds, the local operations comprising: obtaining channel measurements (h^{ij}) for wireless links between the UE device and access point (AP) nodes of the network; updating local primal parameters (θⁱ, xⁱ) and local dual parameters (λⁱ, μⁱ) of a machine learning (ML) model of a radio resource management (RRM) optimization problem based on the channel measurements; determining a RRM decision for a downlink transmission from a particular AP node to the UE device based on the ML model with the updated local primal parameters and updated local dual parameters; and causing the RRM decision to be transmitted to the particular AP node, the RRM decision to be implemented by the particular AP node for the downlink data transmission from the particular AP node to the UE device; and perform global operations after the number of rounds of local operations, the global operations comprising: updating global primal parameters (ρ^{ji}) of the ML model; causing the updated global primal parameters to be transmitted to one or more aggregator nodes of the network; and obtaining updated global dual parameters (ν^{ji}) of the ML model from one or more aggregator nodes of the network based on the updated global primal parameters; wherein the processor is further to perform additional rounds of the local operations based on the updated global primal parameters and updated global dual parameters.

Example U24 includes the subject matter of Example U23, wherein the RRM optimization problem is for one of a transmit power for a downlink data transmission and a frequency band to transmit the downlink data transmission on.

Example U25 includes the subject matter of Example U23 or U24, wherein the local and global dual parameters are Lagrange variables corresponding to constraints of the RRM optimization problem.

Example P1 includes method to be performed at an apparatus of an edge compute node in an edge computing network, the method including: performing local update operations including: obtaining channel measurements (h^{ij}); updating local primal parameters (θⁱ, xⁱ) and local dual parameters (λⁱ, μⁱ) to a machine learning model of an optimization problem based on the channel measurements and a subset of global primal parameters (ρⁱ) and global dual parameters (νⁱ), wherein the local and global dual parameters include Lagrange variables corresponding to constraints of the optimization problem; determining a radio resource management (RRM) decision for a link between the edge compute node and another edge compute node based on the updated machine learning model; and initiating a data transmission based on the RRM decision. The method also includes performing global update operations including: exchanging global primal parameter information (ρ^{ji}) with one or more aggregators at other nodes of the edge computing network; obtaining updates to the global dual parameters (ν^{ji}) from the aggregators; and updating the machine learning model based on the updated global primal and dual parameters.

Example P2 includes the subject matter of Example P1, and/or some other example(s) herein, and optionally, wherein the global primal parameters indicate expected power outputs for a transmitter in the edge computing network, and the global dual parameters indicate sensitivities of receivers to other transmitters.

Example P3 includes the subject matter of Example P1 or P2, and/or some other example(s) herein, and optionally, wherein obtaining channel measurements includes obtaining additional channel measurements from another node of the edge computing system, and the local parameters are updated further based on the additional channel measurements.

Example P4 includes the subject matter of any one of Examples P 1-P3, and/or some other example(s) herein, and optionally, wherein updating the local primal and dual parameters to the machine learning model is further based on one or more of: previous RRM decisions for the link, previous RRM decisions for other links of the edge computing system, constraints to one or both edge compute nodes of the link, and information from other RRM decision-makers of the edge computing system.

Example P5 includes the subject matter of any one of Examples P1-P4, and/or some other example(s) herein, and optionally, wherein updating the local primal and dual parameters is based on a gradient descent analysis.

Example P6 includes the subject matter of any one of Examples P1-P5, and/or some other example(s) herein, and optionally, wherein the local update operations further comprising updating estimates of functions used in the optimization problem.

Example P7 includes the subject matter of any one of Examples P 1-P6, and/or some other example(s) herein, and optionally, wherein the edge compute node is an access point (AP) or base station (BS) of an edge computing system.

Example P8 includes the subject matter of Example P7, and/or some other example(s) herein, and optionally, wherein the data transmission is an uplink transmission from the AP or BS to a user equipment (UE) device of the edge computing system.

Example P9 includes the subject matter of any one of Examples P1-P6, and/or some other example(s) herein, and optionally, wherein the edge compute node is a user equipment (UE) device of an edge computing system.

Example P10 includes the subject matter of Example P9, and/or some other example(s) herein, and optionally, wherein the data transmission is a downlink transmission from the UE device to an access point (AP) or base station (BS) of an edge computing system.

Example P11 includes the subject matter of Example P9 or P10, and/or some other example(s) herein, and optionally, further comprising causing the updated global dual parameters to be sent to the UE device.

Example P12 includes the subject matter of any preceding Example, and/or some other example(s) herein, and optionally, wherein the global primal parameter information is exchanged with an aggregator at a central node of the edge computing system.

Example P13 includes the subject matter of any preceding Example, and/or some other example(s) herein, and optionally, wherein global primal parameter information is exchanged with an aggregator at an access point (AP) or base station (BS) of the edge computing system.

Example P14 includes the subject matter of any preceding Example, and/or some other example(s) herein, and optionally, wherein the global primal parameter information is exchanged with multiple aggregators at respective nodes of the edge computing network, each aggregator responsible for updating a respective subset of the global dual parameters.

Example P15 includes the subject matter of Example P14, and/or some other example(s) herein, and optionally, wherein a first aggregator is at a central node of the edge computing system and a second aggregator is at an access point of the edge computing system.

Example P16 includes the subject matter of Example P14, and/or some other example(s) herein, and optionally, wherein a first aggregator is at a first access point (AP) of the edge computing system and a second aggregator is at a second AP of the edge computing system.

Example P17 includes the subject matter of Example P14, and/or some other example(s) herein, and optionally, wherein a first aggregator is at a first central node (CN) of the edge computing system and a second aggregator is at a second CN of the edge computing system.

Example P18 includes the subject matter of any preceding Example, and/or some other example(s) herein, and optionally, wherein the local update operations are performed in multiple rounds before the global update operations are performed.

Example P19 includes the subject matter of any preceding Example, and/or some other example(s) herein, and optionally, further comprising performing the local update operations after the global update operations are performed.

Example P20 includes an apparatus comprising means to perform one or more elements of a method described in or related to any of Examples P1-P19 above, or any other method or process described herein.

Example P21 includes one or more non-transitory computer-readable media comprising instructions to cause an electronic device, upon execution of the instructions by one or more processors of the electronic device, to perform one or more elements of a method described in or related to any of Examples P1-P19, or any other method or process described herein.

Example P22 includes an apparatus comprising logic, modules, or circuitry to perform one or more elements of a method described in or related to any of Examples P1-P19, or any other method or process described herein.

Example P23 includes a method, technique, or process as described in or related to any of Examples P1-P19, or portions or parts thereof.

Example P24 includes an apparatus comprising: one or more processors and one or more computer-readable media comprising instructions that, when executed by the one or more processors, cause the one or more processors to perform the method, techniques, or process as described in or related to any of Examples P1-P19, or portions thereof.

Example P25 includes a signal as described in or related to any of Examples P1-P19, or portions or parts thereof.

Example P26 includes a datagram, packet, frame, segment, protocol data unit (PDU), or message as described in or related to any of Examples P1-P19, or portions or parts thereof, or otherwise described in the present disclosure.

Example P27 includes a signal encoded with data as described in or related to any of Examples P1-P19, or portions or parts thereof, or otherwise described in the present disclosure.

Example P28 includes a signal encoded with a datagram, packet, frame, segment, protocol data unit (PDU), or message as described in or related to any of Examples P1-P19, or portions or parts thereof, or otherwise described in the present disclosure.

Example P29 includes an electromagnetic signal carrying computer-readable instructions, wherein execution of the computer-readable instructions by one or more processors is to cause the one or more processors to perform the method, techniques, or process as described in or related to any of Examples P1-P19, or portions thereof.

Example P30 includes a computer program comprising instructions, wherein execution of the program by a processing element is to cause the processing element to carry out the method, techniques, or process as described in or related to any of Examples P1-P19, or portions thereof.

Example P31 includes a signal in a wireless network as shown and described herein.

Example P32 includes a method of communicating in a wireless network as shown and described herein.

Example P33 includes a system for providing wireless communication as shown and described herein.

Example P34 includes a device for providing wireless communication as shown and described herein.

An example implementation is an edge computing system, including respective edge processing devices and nodes to invoke or perform the operations of Examples P1-P19, or other subject matter described herein.

Another example implementation is a client endpoint node, operable to invoke or perform the operations of Examples P1-P19, or other subject matter described herein.

Another example implementation is an aggregation node, network hub node, gateway node, or core data processing node, within or coupled to an edge computing system, operable to invoke or perform the operations of Examples P1-P19, or other subject matter described herein.

Another example implementation is an access point, base station, road-side unit, street-side unit, or on-premise unit, within or coupled to an edge computing system, operable to invoke or perform the operations of Examples P1-P19, or other subject matter described herein.

Another example implementation is an edge provisioning node, service orchestration node, application orchestration node, or multi-tenant management node, within or coupled to an edge computing system, operable to invoke or perform the operations of Examples P1-P19, or other subject matter described herein.

Another example implementation is an edge node operating an edge provisioning service, application or service orchestration service, virtual machine deployment, container deployment, function deployment, and compute management, within or coupled to an edge computing system, operable to invoke or perform the operations of Examples P1-P19, or other subject matter described herein.

Another example implementation is an edge computing system operable as an edge mesh, as an edge mesh with side car loading, or with mesh-to-mesh communications, operable to invoke or perform the operations of Examples P1-P19, or other subject matter described herein.

Another example implementation is an edge computing system including aspects of network functions, acceleration functions, acceleration hardware, storage hardware, or computation hardware resources, operable to invoke or perform the use cases discussed herein, with use of Examples P1-P19, or other subject matter described herein.

Another example implementation is an edge computing system adapted for supporting client mobility, vehicle-to-vehicle (V2V), vehicle-to-everything (V2X), or vehicle-to-infrastructure (V2I) scenarios, and optionally operating according to ETSI MEC specifications, operable to invoke or perform the use cases discussed herein, with use of Examples P1-P19, or other subject matter described herein.

Another example implementation is an edge computing system adapted for mobile wireless communications, including configurations according to an 3GPP 4G/LTE, 5G, or ORAN (Open RAN) network capabilities, operable to invoke or perform the use cases discussed herein, with use of Examples P1-P19, or other subject matter described herein.

Any of the above-described examples may be combined with any other example (or combination of examples), unless explicitly stated otherwise. Aspects described herein can also implement a hierarchical application of the scheme for example, by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc. Some of the features in the present disclosure are defined for network elements (or network equipment) such as Access Points (APs), eNBs, gNBs, core network elements (or network functions), application servers, application functions, etc. Any embodiment discussed herein as being performed by a network element may additionally or alternatively be performed by a UE, or the UE may take the role of the network element (e.g., some or all features defined for network equipment may be implemented by a UE).

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations to provide greater bandwidth/throughput and to support edge services selections that can be made available to the edge systems being serviced. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

1-64. (canceled)

65. An apparatus of an access point (AP) node of a network, the apparatus including an interconnect interface to connect the apparatus to one or more components of the AP node, and a processor to:
perform local update operations for a machine learning (ML) model of a radio resource management (RRM) optimization problem, the local update operations comprising:
obtaining channel measurements (h^{ij}) for wireless links between the AP node and user equipment (UE) devices;
updating first parameters of the ML model based on the channel measurements;
determining a RRM decision for an uplink transmission from a particular UE device to the AP node based on the ML model with the updated first set of parameters; and
causing the RRM decision to be transmitted to the particular UE device, the RRM decision to be implemented by the particular UE device for the uplink data transmission from the particular UE device to the AP node.

66. The apparatus of claim 65, wherein the processor is further to perform global update operations for the ML model, the global update operations comprising:
updating second parameters of the ML model;
causing the updated second parameters to be transmitted to one or more aggregator nodes of the network; and
obtaining updated third parameter of the ML model from one or more aggregator nodes of the network based on the updated global primal parameters.

67. The apparatus of claim 66, wherein the processor is further to perform additional rounds of the local operations based on the updated global primal parameters and updated global dual parameters.

68. The apparatus of claim 66, wherein the one or more aggregator nodes of the network include a central node of the network or another AP node.

69. The apparatus of claim 66, wherein the RRM optimization problem is a primal-dual optimization problem.

70. The apparatus of claim 69, first parameters of the ML model include local primal parameters (θⁱ, xⁱ) and local dual parameters (λⁱ, μⁱ) of the ML model.

71. The apparatus of claim 69, wherein the second parameters of the ML model include global primal parameters (ρ^{ji}) of the ML model, and the third parameters of the ML model include global dual parameters (ν^{ji}) of the ML model.

72. The apparatus of claim 69, wherein the dual parameters are Lagrange variables corresponding to constraints of the RRM optimization problem.

73. The apparatus of claim 66, wherein the second parameters indicate expected power outputs for transmitters in the network, and the third parameters indicate sensitivities of receivers to other transmitters.

74. The apparatus of claim 65, wherein the processor is to update the first parameters based on a gradient descent analysis.

75. The apparatus of claim 65, wherein the processor is to update the first parameters of the ML model further based on one or more of: previous RRM decisions for the link between the particular UE device and the AP node, previous RRM decisions for other AP-UE links of the network, constraints to one or both of the AP or particular UE device, and information from other RRM decision-makers of the network.

76. The apparatus of claim 65, wherein the processor is to update the first parameters further based on additional channel measurements obtained by other AP nodes of the network.

77. The apparatus of claim 65, wherein the RRM optimization problem is for one of a transmit power for an uplink data transmission and a frequency band to transmit the uplink data transmission on.

78. The apparatus of claim 65, wherein the processor is further, in the local update operations, to update estimates of functions used in the RRM optimization problem.

79. The apparatus of claim 65, wherein the ML model is a neural network (NN).

80. The apparatus of claim 65, wherein the AP node is a base station of a cellular network.

81. A method comprising:
performing local update operations for a machine learning (ML) model of a radio resource management (RRM) optimization problem, the local update operations comprising:
obtaining channel measurements (h^{ij}) for wireless links between the AP node and user equipment (UE) devices;
updating first parameters of the ML model based on the channel measurements;
determining a RRM decision for an uplink transmission from a particular UE device to the AP node based on the ML model with the updated first set of parameters; and
causing the RRM decision to be transmitted to the particular UE device, the RRM decision to be implemented by the particular UE device for the uplink data transmission from the particular UE device to the AP node.

82. The method of claim 81, further comprising performing global update operations for the ML model, the global update operations comprising:
updating second parameters of the ML model;
causing the updated second parameters to be transmitted to one or more aggregator nodes of the network; and
obtaining updated third parameter of the ML model from one or more aggregator nodes of the network based on the updated global primal parameters.

83. The method of claim 82, wherein the RRM optimization problem is a primal-dual optimization problem, the first parameters of the ML model include local primal parameters (θⁱ, xⁱ) and local dual parameters (λⁱ, μⁱ) of the ML model, the second parameters of the ML model include global primal parameters (ρ^{ji}) of the ML model, the third parameters of the ML model include global dual parameters (ν^{ji}) of the ML model, and the dual parameters are Lagrange variables corresponding to constraints of the RRM optimization problem.

84. The method of claim 81, wherein updating the first parameters is based on one or more of: previous RRM decisions for the link between the particular UE device and the AP node, previous RRM decisions for other AP-UE links of the network, constraints to one or both of the AP or particular UE device, and information from other RRM decision-makers of the network.

85. One or more computer-readable media comprising instructions that, when executed by one or more processors of an access point (AP) node of a network, cause the one or more processors to perform local update operations for a machine learning (ML) model of a radio resource management (RRM) optimization problem, the local update operations comprising:
obtaining channel measurements (h^{ij}) for wireless links between the AP node and user equipment (UE) devices;
updating first parameters of the ML model based on the channel measurements;
determining a RRM decision for an uplink transmission from a particular UE device to the AP node based on the ML model with the updated first set of parameters; and
causing the RRM decision to be transmitted to the particular UE device, the RRM decision to be implemented by the particular UE device for the uplink data transmission from the particular UE device to the AP node.

86. The computer-readable media of claim 85, wherein the instructions are further to cause the one or more processors to perform global update operations for the ML model, the global update operations comprising:
updating second parameters of the ML model;
causing the updated second parameters to be transmitted to one or more aggregator nodes of the network; and
obtaining updated third parameter of the ML model from one or more aggregator nodes of the network based on the updated global primal parameters.

87. The computer-readable media of claim 86, wherein the RRM optimization problem is a primal-dual optimization problem, the first parameters of the ML model include local primal parameters (θⁱ, xⁱ) and local dual parameters (λⁱ, μⁱ) of the ML model, the second parameters of the ML model include global primal parameters (π^{ji}) of the ML model, the third parameters of the ML model include global dual parameters (ν^{ji}) of the ML model, and the dual parameters are Lagrange variables corresponding to constraints of the RRM optimization problem.

88. The computer-readable media of claim 85, wherein updating the first parameters is based on one or more of: previous RRM decisions for the link between the particular UE device and the AP node, previous RRM decisions for other AP-UE links of the network, constraints to one or both of the AP or particular UE device, and information from other RRM decision-makers of the network.

89. The computer-readable media of claim 85, wherein updating the first parameters is based on one or more of: previous RRM decisions for the link between the particular UE device and the AP node, previous RRM decisions for other AP-UE links of the network, constraints to one or both of the AP or particular UE device, and information from other RRM decision-makers of the network.
